(19) United States
(12) Patent Application Publication
(10) Pub. No.: US 2024/0264348 A1
(43) Pub. Date: Aug. 8, 2024

(54) TRANSMISSION STRUCTURE AND PREPARATION METHOD THEREOF

(71) Applicants: NANJING UNIVERSITY, Nanjing (CN); NANJING STAR HIDDEN TECHNOLOGY DEVELOPMENT CO., LTD., Nanjing (CN)

(72) Inventors: Hongchen CHU, Nanjing (CN); Yun LAI, Nanjing (CN); Xiang XIONG, Nanjing (CN); Ruwen PENG, Nanjing (CN); Mu WANG, Nanjing (CN)

(73) Assignees: NANJING UNIVERSITY, Nanjing (CN); NANJING STAR HIDDEN TECHNOLOGY DEVELOPMENT CO., LTD., Nanjing (CN)

(21) Appl. No.: 18/634,296

(22) Filed: Apr. 12, 2024

Related U.S. Application Data
(63) Continuation of application No. PCT/CN2021/123600, filed on Oct. 13, 2021.

(51) Int. Cl. G02B 5/28

(52) U.S. Cl. CPC G02B 5/282

(57) ABSTRACT

The present disclosure relates to a transmission structure and a preparation method thereof. The transmission structure includes a plurality of first transmission units and a plurality of second transmission units, and difference between a first transmission phase of a transmitted electromagnetic wave of the first transmission unit and a second transmission phase of a transmitted electromagnetic wave of the second transmission unit is the same or similar within a preset frequency range. The plurality of first and second transmission units are arranged randomly on a surface. The first transmission unit has a first matrix, a first medium block is disposed inside the first matrix, and a thickness of the first matrix between the first medium block and an electromagnetic wave incident surface of the first transmission unit is a non-zero first thickness. The second transmission unit has a second matrix, a second medium block is disposed inside the second matrix, a thickness of the second matrix between the second medium block and an electromagnetic wave incident surface of the second transmission unit is a non-zero second thickness, and the first and second thicknesses are configured to enable the first and second transmission units to have a large phase difference of reflected electromagnetic waves in a wide frequency range.

### CROSS-REFERENCE TO RELATED APPLICATIONS

The present disclosure is a Continuation Application of International Application No. PCT/CN2021/123600, filed on Oct. 13, 2021, the entire contents of which are incorporated herein by reference.

### TECHNICAL FIELD

The present disclosure relates to the field of electromagnetic wave imaging technology, and more particularly relates to a transmission structure and a preparation method thereof.

### BACKGROUND

The invention and use of glass have greatly facilitated people's lives. It has become an irreplaceable material in our daily lives. Ordinary transparent glass, such as window glass on exterior walls of ordinary buildings, car windshields, etc., has a smooth surface. Both transmitted and reflected light from this ordinary glass can be imaged. For example, we can see objects outdoors through the glass from indoors. When the outdoor illumination is weak, people indoors can still see the mirror image (virtual image) of indoor objects on the glass. On the other hand, when there are inappropriate brightness distributions in the surrounding environment, these brightness distributions will also be reflected by the glass and thus cause light pollution, thereby causing people's visual fatigue or discomfort.

In the conventional technology, the above light pollution problem may be solved by forming rough and matt structures (such as frosted glass) on a surface of the glass to cause diffuse reflection of light. However, since neither the transmitted light nor the reflected light can form images when light is irradiated on such a structure, people cannot obtain information through the transmitted light, which easily causes inconvenience to people's lives.

On the other hand, the Chinese invention patent with Publication No. CN110854539B proposes a transmission structure capable of causing diffuse reflection of incident light on a surface, substantially avoiding mirror reflection of the incident light on a glass surface, while keeping the wavefront of the transmitted light unchanged. The glass made of this transmission structure can not only eliminate light pollution caused by inappropriate brightness distributions due to the mirror reflection, but also keep the wavefront of the transmitted light substantially undisturbed, so that people can still obtain information through the transmitted light. However, this type of transmission structure can only achieve the above effects in a narrow frequency band and is not suitable for the preparation of macro-scale products.

### SUMMARY

According to various embodiments of the present disclosure, a transmission structure is provided.

A transmission structure includes a plurality of first transmission units and a plurality of second transmission units, wherein the plurality of first transmission units and the plurality of second transmission units are arranged randomly on a surface, and electromagnetic wave incident surfaces of the plurality of first transmission units and electromagnetic wave incident surfaces of the plurality of second transmission units jointly form an electromagnetic wave incident surface of the transmission structure; wherein
the first transmission unit has a first matrix, a first medium block is disposed inside the first matrix, and a thickness of the first matrix between the first medium block and the electromagnetic wave incident surface of the first transmission unit is a non-zero first thickness; the second transmission unit has a second matrix, a second medium block is disposed inside the second matrix, a thickness of the second matrix between the second medium block and the electromagnetic wave incident surface of the second transmission unit is a non-zero second thickness, and the second thickness is different from the first thickness; and when electromagnetic waves are incident on the first and second transmission units, the transmitted electromagnetic wave of the first transmission unit has the first transmission phase φₜ₁, the transmitted electromagnetic wave of the second transmission unit has the second transmission phase φₜ₂, and the first transmission phase φₜ₁, and the second transmission phase φₜ₂ satisfy 0≤β|φₜ₁−φₜ₂|≤0.5π within the preset frequency band; a reflected electromagnetic wave of the first matrix is a first reflected electromagnetic wave, a reflected electromagnetic wave of the first medium block is a second reflected electromagnetic wave, and the first thickness is configured to enable the reflected electromagnetic wave of the first transmission unit to have a first reflection phase φᵣ₁ at least through the interference of the first and second reflected electromagnetic waves; a reflected electromagnetic wave of the second matrix is a third reflected electromagnetic wave, a reflected electromagnetic wave of the second medium block is a fourth reflected electromagnetic wave, and the second thickness is configured to enable the reflected electromagnetic wave of the second transmission unit to have a second reflection phase φᵣ₂ at least through the interference of the third and fourth reflected electromagnetic waves; and the first reflection phase g, and the second reflection phase φᵣ₂ satisfy 0.6π≤|φᵣ₁−φᵣ₂|≤1.4π within the preset frequency band.

According to another aspect of the present disclosure, a transmission structure is provided, including:
a matrix having an electromagnetic wave incident surface and comprising a plurality of first transmission portions and a plurality of second transmission portions randomly distributed; wherein each of the first transmission portions is disposed with a first medium block to form a first transmission unit, and a thickness of the matrix between the first medium block and the electromagnetic wave incident surface is a non-zero first thickness; each of the second transmission portions is disposed with a second medium block to form a second transmission unit, a thickness of the matrix between the second medium block and the electromagnetic wave incident surface is a non-zero second thickness, and the second thickness is different from the first thickness; and
wherein when electromagnetic waves are incident on the first and second transmission units,
the transmitted electromagnetic wave of the first transmission unit has a first transmission phase φₜ₁, the transmitted electromagnetic wave of the second transmission unit has a second transmission phase φₜ₂, and the first transmission phase φₜ₁ and the second transmission phase ₜ₂ satisfy 0≤|φₜ₁−φₜ₂|≤0.5π within a preset frequency band;
a reflected electromagnetic wave of the first transmission portion is a first reflected electromagnetic wave, a reflected electromagnetic wave of the first medium block is a second reflected electromagnetic wave, and the first thickness is configured to enable the reflected electromagnetic wave of the first transmission portion to have a first reflection phase φᵣ₁ at least through the interference of the first and second reflected electromagnetic waves; a reflected electromagnetic wave of the second transmission portion is a third reflected electromagnetic wave, a reflected electromagnetic wave of the second medium block is a fourth reflected electromagnetic wave, and the second thickness is configured to enable the reflected electromagnetic wave of the second transmission unit to have a second reflection phase φᵣ₂ at least through the interference of the third and fourth reflected electromagnetic waves; and the first reflection phase φᵣ₁ and the second reflection phase φᵣ₂ satisfy 0.67π≤(φᵣ₁−φᵣ₂|≤1.4π within the preset frequency band.

According to yet another aspect of the present disclosure, a preparation method of a transmission structure is provided, including:
providing a first substrate, wherein the first substrate has an electromagnetic wave incident surface, and comprises a plurality of first transmission areas and a plurality of second transmission areas; forming a patterned first medium layer on the first substrate, wherein the patterned first medium layer comprises a plurality of the first medium blocks, and each of the first medium blocks and each of the first transmission areas are in one-to-one correspondence; forming a second substrate on the first substrate and the patterned first medium layer; forming a patterned second medium layer on the second substrate, wherein the patterned second medium layer includes a plurality of the second medium blocks, each of the second medium blocks and each of the second transmission areas are in one-to-one correspondence, the first and second medium blocks have first and second projections on the electromagnetic wave incident surface in a normal direction of the electromagnetic wave incident surface, respectively, the first and second projections are randomly distributed, and the first projection does not overlap the second projection; and forming a third substrate on the second substrate and the patterned second medium layer,
wherein the first, second and third substrates are made of a same material, the first transmission area and at least the first medium block, a portion of the second substrate, and a portion of the third substrate corresponding to the first transmission area form the first transmission unit, and the second transmission area and at least a portion of the second substrate, the second medium block, and a portion of the third substrate corresponding to the second transmission area form the second transmission unit.

According to yet another aspect of the present disclosure, a preparation method of a transmission structure is provided, including:
providing a first substrate with an electromagnetic wave incident surface; forming a photoresist layer with a first pattern on the first substrate, wherein the photoresist layer with the first pattern comprises a plurality of first medium holes, and a portion of the first substrate corresponding to the first medium holes is a first transmission area; forming first medium blocks in the first medium holes; removing at least the photoresist layer with the first pattern; forming a patterned first medium layer by a plurality of the first medium blocks on the first substrate; forming a second substrate on the first substrate and the patterned first medium layer; forming a photoresist layer with a second pattern on the second substrate, wherein the photoresist layer with the second pattern comprises a plurality of second medium holes, and a portion of the first substrate corresponding to the second medium holes is a second transmission area; forming second medium blocks in the second medium holes, wherein the first and second medium blocks have first and second projections on the electromagnetic wave incident surface in a direction perpendicular to the electromagnetic wave incident surface, respectively, and the first and second projections are distributed randomly, and the first projection does not overlap the second projection; removing at least the photoresist layer with the second pattern; forming a patterned second medium layer by a plurality of the second medium blocks on the second substrate; and forming a third substrate on the second substrate and the patterned second medium layer,
wherein the first, second and third substrates are made of a same material, the first transmission area and at least the first medium block, a portion of the second substrate, and a portion of the third substrate corresponding to the first transmission area form the first transmission unit, and the second transmission area and at least a portion of the second substrate, the second medium block, and a portion of the third substrate corresponding to the second transmission area form the second transmission unit.

According to yet another aspect of the present disclosure, a film including the transmission structure described above is provided.

According to yet another aspect of the present disclosure, a screen including the transmission structure described above is provided.

According to yet another aspect of the present disclosure, a projection system including the transmission structure described above and a projection device configured to project light carrying image information onto the screen to display an image is provided.

According to yet another aspect of the present disclosure, a glass including the transmission structure described above is provided.

According to yet another aspect of the present disclosure, a vehicle including a vehicle body and the glass described above disposed on the vehicle body is provided.

The details of one or more embodiments of the present disclosure are set forth in the accompanying drawings and description below. Other features, objects and advantages of the present disclosure will become apparent from the description, the accompanying drawings, and the claims.

### BRIEF DESCRIPTION OF THE DRAWINGS

To better describe and illustrate embodiments or examples of the present disclosure disclosed herein, reference may be made to one or more accompanying drawings. The additional details or examples used to describe the accompanying drawings should not be construed as limiting the scope of any of the disclosed disclosure, the presently described embodiments or examples, and the presently understood best modes of the present disclosure.

FIG. 1 is a spectrum diagram of a reflection phase difference between electromagnetic waves of two transmission units in the prior art;

FIG. 2 is a schematic structural diagram of two transmission units according to an embodiment of the present disclosure;

FIG. 3 is a schematic diagram of a random arrangement of the two transmission units in the embodiment shown in FIG. 2;

FIG. 4 shows a changing relationship curve of a reflection phase of an electromagnetic wave of a transmission unit versus a thickness of the matrix between the embedded layer and an electromagnetic wave incident surface of the transmission unit and wavelength of an incident electromagnetic wave according to an embodiment of the present disclosure;

FIG. 5 shows an operation schematic diagram of a transmission structure with thermal insulation effect according to an embodiment of the present disclosure;

FIG. 6 shows transmission phase curves of the two transmission units in a visible light frequency band according to a specific embodiment 1 of the present disclosure;

FIG. 7 shows reflection phase curves of the two transmission units in the visible light frequency band according to the specific embodiment 1 of the present disclosure;

FIG. 8 shows reflection phase difference curves of the two transmission units in the visible light frequency band according to the specific embodiment 1 of the present disclosure;

FIG. 9 shows reflectance curves of the two transmission units in the visible light frequency band according to the specific embodiment 1 of the present disclosure;

FIG. 10 shows transmittance curves of the two transmission units in the visible light frequency band according to the specific embodiment 1 of the present disclosure;

FIGS. (a) to (e) of FIG. 11 respectively show far-field energy distribution diagrams and corresponding comparison diagrams when electromagnetic waves of different wavelengths are incident on the transmission structure according to the embodiment 1 of the present disclosure;

FIG. 12 shows transmittance curves of the two transmission units in an infrared light frequency band according to the specific embodiment 1 of the present disclosure;

FIG. 13 shows reflection phase difference curves of the two transmission units in the visible light frequency band according to a specific embodiment 2 of the present disclosure;

FIG. 14 shows reflection phase difference curves of the two transmission units in the visible light frequency band according to a specific embodiment 3 of the present disclosure;

FIG. 15 shows reflection phase difference curves of the two transmission units in the infrared light frequency band according to a specific embodiment 4 of the present disclosure;

FIG. 16 is a schematic structural diagram of a screen according to an embodiment of the present disclosure;

FIG. 17 is a schematic structural diagram of a projection system according to an embodiment of the present disclosure;

FIG. 18 is a schematic structural diagram of a vehicle according to an embodiment of the present disclosure;

FIG. 19 is a schematic diagram of the preparation process of a transmission structure according to an embodiment of the present disclosure.

### DETAILED DESCRIPTION

To make the objects, features and advantages of the present disclosure to be more apparent and understandable, reference will be made to the accompanying drawings and embodiments to describe the present disclosure in detail below. In the following description, numerous specific details are set forth in order to provide a thorough understanding of the present disclosure. However, the present disclosure can be implemented in many other manners different from those described here. Those skilled in the art can make similar improvements without departing from the connotation of the present disclosure. Therefore, the present disclosure is not limited to the specific embodiments disclosed below.

In the description of the present disclosure, it should be understood that the orientations or positional relationships indicated by the terms “center”, “longitudinal”, “lateral”, “length”, “width”, “thickness”, “upper”, “lower”, “front”, “back”, “left”, “right”, “vertical”, “horizontal”, “top”, “bottom”, “inside”, “outside”, “clockwise”, “counterclockwise”, “axial”, “radial”, and “circumferential”, etc., are based on orientation or position relationships shown in the drawings. They are only for the convenience of describing the present disclosure and simplifying the description, do not indicate or imply the indicated devices or elements must have a specific orientation, be constructed and operate in a specific orientation, and therefore they cannot be construed as limitations to the present disclosure.

In addition, the terms “first” and “second” are only used for descriptive purposes and cannot be understood as indicating or implying relative importance or implicitly pointing out the number of indicated technical features. Therefore, features defined with “first” and “second” may explicitly or implicitly include at least one of these features. In the description of the present disclosure, “a plurality of” means at least two, such as two, three, etc., unless clearly and specifically limited otherwise.

It should be noted that when an element is referred to as being “fixed to” or “disposed on” another element, it may be directly on another element or intervening elements may also be present. When an element is considered to be “connected to” another element, it may be directly connected to another element or there may also be intervening elements present. The terms “vertical”, “horizontal”, “upper”, “lower”, “left”, “right” and similar expressions used herein are for illustrative purposes only and do not represent the only implementation.

The transmission structure proposed in the Chinese invention patent with Publication No. CN110854539B can only achieve a large reflection phase difference between electromagnetic waves of two transmission units in a narrow frequency band, such as 0.6π˜1.4π (or −1.4π˜−0.6π), and further 0.8π˜1.2π (or −1.27˜−0.87π). In particular, the transmission structure of the above patent can only achieve the reflection phase difference of π (or −π) between the electromagnetic waves of the two transmission units at a single frequency point.

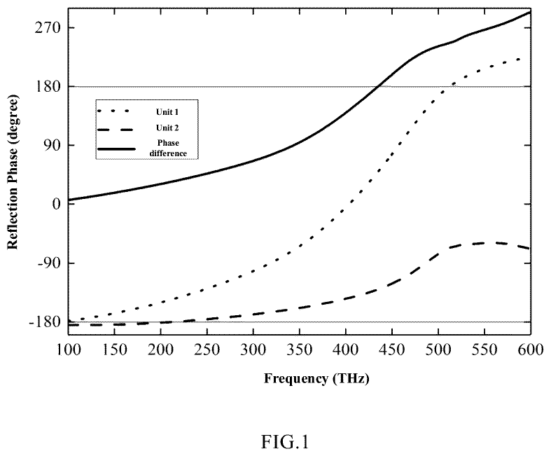

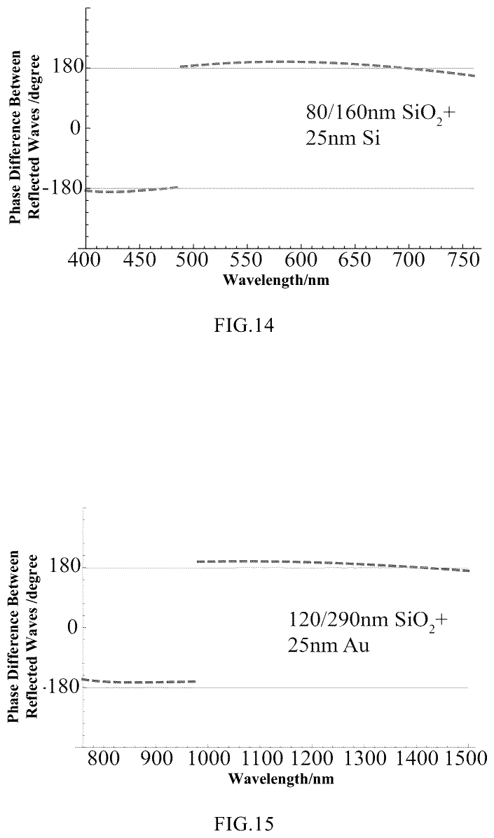

Specifically, as a comparison, FIG. 1 of the present disclosure shows the spectrum of the reflection phase difference between the electromagnetic waves of the two transmission units of the embodiment shown in FIG. 14 of the above patent, where the dotted line shows the change of the reflection phase of the electromagnetic wave of the transmission unit 1 with the frequency, the dashed line shows the change of the reflection phase of the electromagnetic wave of the transmission unit 2 with the frequency, and the solid black line shows the change of the reflection phase difference between the electromagnetic waves of the transmission units 1 and 2 with the frequency. It can be seen that the transmission units 1 and 2 meet that the reflection phase difference between the electromagnetic waves of the two transmission units is 0.6π˜1.4π only near the frequency range of 360 THz˜520 THz (corresponding to about 577 nm˜833 nm). Further, the transmission units 1 and 2 meet that the reflection phase difference between the electromagnetic waves of the two transmission units is 0.8π˜1.2π only near the frequency range of 440 THz˜460 THz. In particular, the transmission units 1 and 2 achieve that the reflection phase difference between the electromagnetic waves of the two transmission units is substantially constant to π only near a single frequency point (i.e., 430 Hz). Therefore, it can be known that it is difficult for the transmission structure in the prior art to achieve an effect that the reflected waves form obvious diffuse reflection without substantially disturbing the wavefront of the transmitted waves in a large wide frequency range.

Based on the above problem, the present disclosure provides a transmission structure capable of achieving the effects that the reflected waves form obvious diffuse reflection without substantially disturbing the wavefront of the transmitted waves, and the mirror reflection to the surrounding environment is substantially eliminated in a large wide frequency range.

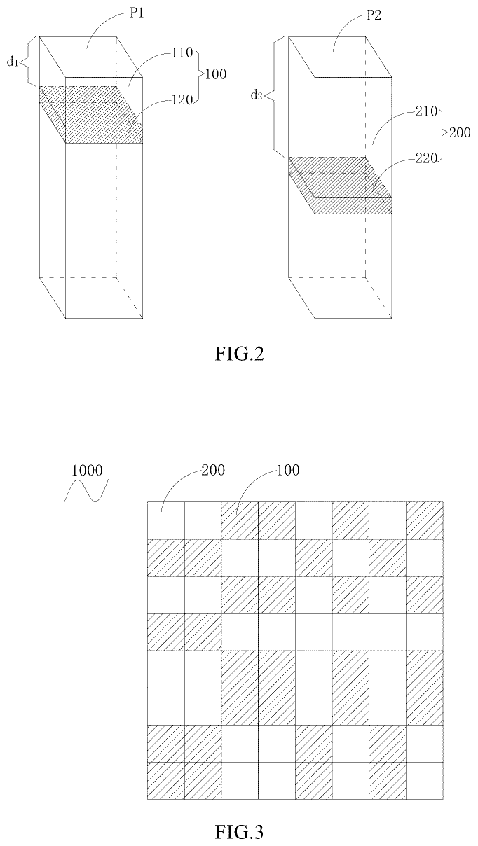

As shown in FIGS. 2 and 3, the transmission structure 1000 of the present disclosure includes a plurality of first transmission units 100 and a plurality of second transmission units 200. The plurality of first transmission units 100 and the plurality of second transmission units 200 are arranged randomly on a surface. The first transmission unit 100 has a first matrix 110, a first medium block 120 is disposed inside the first matrix 110, and a thickness of the first matrix 110 between the first medium block 120 and an electromagnetic wave incident surface P1 of the first transmission unit 100 is a non-zero first thickness. The second transmission unit 200 has a second matrix 210, a second medium block 220 is disposed inside the second matrix 210, and a thickness of the second matrix 210 between the second medium block 220 and an electromagnetic wave incident surface P2 of the second transmission unit 200 is a non-zero second thickness, which is different from the first thickness. When the electromagnetic waves are incident on the first and second transmission units 100 and 200, a first transmission phase φₜ₁ of the transmitted electromagnetic wave of the first transmission unit 100 and a second transmission phase φₜ₂ of the transmitted electromagnetic wave of the second transmission unit 200 satisfy 0≤|φₜ₁−φₜ₂|≤0.5π within a preset frequency band. The preset frequency band may be an operating frequency band of the transmission structure 1000, in which the transmission structure 1000 can achieve the effects that the reflected waves form obvious diffuse reflection without substantially disturbing the wavefront of the transmitted waves, and the mirror reflection of the transmission structure 1000 is substantially eliminated. Optionally, the bandwidth of the preset frequency band may be smaller than the bandwidth of the operating frequency band of the transmission structure 1000, that is, the preset frequency band may be within the operating frequency band of the transmission structure 1000.

The electromagnetic wave incident surfaces P1 of the plurality of first transmission units 100 and the electromagnetic wave incident surfaces P2 of the plurality of second transmission units 200 jointly form an electromagnetic wave incident surface of the transmission structure 1000. In other words, the plurality of first transmission units 100 and the plurality of second transmission units 200 should be arranged randomly without any gaps. In other words, two adjacent first and two transmission units 100 and 200 should be disposed in surface contact.

In addition, by controlling the transmission phase (first transmission phase) of the electromagnetic wave of the first transmission unit 100 and the transmission phase (second transmission phase) of the electromagnetic wave of the second transmission unit 200 to satisfy 0≤φₜ₁−φₜ₂|≤0.5π, electromagnetic waves reflected by an object on one side of the transmission structure 1000 can transmit through the transmission structure 1000 without disturbing the wavefront of the transmitted electromagnetic waves, so that the energy of the transmitted electromagnetic waves is concentrated on the transmission side, which is conducive for human eyes or a visual apparatus to capture the complete wavefront information of the transmitted electromagnetic waves reflected by the object, thereby enabling clear identification of the object behind the transmission structure. Specifically, the transmission phase difference between the electromagnetic waves of the two transmission units may be 0, 0.1π, 0.2π, 0.3π, 0.4π and 0.5π. Specifically, by controlling an optical path difference between the electromagnetic waves passing through the first and second transmission units 100 and 200 to satisfy a certain range, the transmission phases of the electromagnetic waves of the two transmission units may satisfy the above relationship. Optionally, when the first and second transmission units 100 and 200 are configured such that optical paths of the electromagnetic waves passing through the first and second transmission unit 100 and 200 are substantially the same, it can be considered that the transmission phases of the first and second transmission units 100 and 200 are substantially the same. Therefore, when the dielectric constant and magnetic permeability of the first matrix 110 are similar with that of the second matrix 210, and the medium constant, magnetic permeability, and thickness of the first medium block 120 are similar with that of the second medium block 220, it may be considered that the optical paths of the electromagnetic waves passing through the first and second transmission units 100 and 200 are substantially the same, and thus the phase difference between the electromagnetic waves transmitted by the first and second transmission units 100 and 200 can substantially satisfy 0≤|φₜ₁−φₜ₂|≤0.5 π. “Similar” may be considered to mean that the relative dielectric constant of the second matrix 210 is within the range of the relative dielectric constant of the first matrix 110±0.5. For example, the dielectric constants of glass and solid acetic acid (or yellow phosphorus or hard rubber) are similar (the relative dielectric constants of both are around 4.1), then the glass may be used as the first matrix, and the solid acetic acid (or yellow phosphorus or hard rubber) may be used as the second matrix. The material selection of the first and second medium blocks 210 and 220 may be similar to the above situation, and will not be described repeatedly here.

Optionally, the plurality of first transmission units 100 and the plurality of second transmission units 200 are randomly arranged on a surface in a sequence shown in FIG. 3. It can be understood that the arrangement positions of the above first and second transmission units 100 and 200 may also be interchanged. Of course, the transmission structure may also be arranged through other random sequences, and the arrangement sequence in FIG. 3 is only an example. In addition, the surface, on which the plurality of first transmission units 100 and the plurality of second transmission units 200 are arranged, may be a flat surface, a curved surface, or a bent surface. The present disclosure does not limit the shape of this surface.

Optionally, the first medium block 120 may be disposed in the first matrix 110 in the form of a film layer structure, and the second medium block 220 may be disposed in the second matrix 210 in the form of a film layer structure, which is conducive to simplifying the preparation of the transmission unit. Optionally, the first matrix 110 is separated by the first medium block 120 to form upper and lower portions, and the second matrix 210 is separated by the second medium block 220 to form upper and lower portions, which is also conducive to preparing the transmission units, and to achieving effective heat insulation when the material of the embedded layer is selected as metal or other materials that may block infrared radiation. Optionally, the electromagnetic wave incident surface of the first medium block 120 is parallel to the electromagnetic wave incident surface of the first transmission unit 100, and the electromagnetic wave incident surface of the second medium block 220 is parallel to the electromagnetic wave incident surface of the second transmission unit 200, which is conducive to forming the first and second medium blocks 120 and 220, and also facilitates the size setting of the first and second thicknesses.

Optionally, both of the first and second matrices 110 and 210 may be any one of a cylinder, a cuboid, a cube, a cone, and a frustum, which is conducive to the selection and preparation of different styles of the first and second matrices 110 and 210, and is further conducive to the preparation of different styles of transmission structures 1000 to adapt to different preparation needs. For example, when the first and second matrices 110 and 210 are hexagonal prisms, it is conducive to enhancing the structural stability of the transmission structure 1000.

By reasonably configuring the first thickness and the second thickness, when the electromagnetic waves are incident on the first and second transmission units 100 and 200, the difference between the first reflection phase φᵣ₁ of the reflected electromagnetic wave of the first transmission unit 100 and the second reflection phase φᵣ₂ of the second transmission unit 200 satisfies 0.6π|φᵣ₁−φᵣ₂|≤1.4π within the preset frequency band, which is conducive to achieving, by the transmission structure 1000, the effect of a large phase difference between the reflected electromagnetic waves of the first and second transmission units 100 and 200 in a wide frequency range.

Specifically, the reflected electromagnetic wave of the first transmission unit 100 may be expressed as the coherent superposition of the reflected electromagnetic wave (a first reflected electromagnetic wave) generated on the electromagnetic wave incident surface of the first matrix 110 and the reflected electromagnetic wave (a second reflected electromagnetic wave) generated on the electromagnetic wave incident surface of the first medium block 120, that is, the interference of the first and second reflected electromagnetic waves, and the reflected electromagnetic wave of the second transmission unit 200 may be expressed as the coherent superposition of the reflected electromagnetic wave (a third reflected electromagnetic wave) generated on the electromagnetic wave incident surface of the second matrix 210 and the reflected electromagnetic wave (a fourth reflected electromagnetic wave) generated on the electromagnetic wave incident surface of the second medium block 220, that is, the interference of the third and fourth reflected electromagnetic waves. Generally, there is a one-way phase difference between the reflected electromagnetic wave of the first transmission unit 100 and the reflected electromagnetic wave of the second transmission unit 200 that changes with the change of frequency. However, since the first thickness of the first transmission unit 100 and the second thickness of the second transmission unit 200 are different, when the frequency of the incident electromagnetic wave changes, a phase change rate of the reflected electromagnetic wave (the second reflected electromagnetic wave) of the first medium block 120 is different from a phase change rate of the reflected electromagnetic wave (the fourth reflected electromagnetic wave) of the second medium block 220. Therefore, by reasonably configuring the first and second thicknesses, and the reflection phases of the reflected electromagnetic waves (i.e., the first reflected electromagnetic wave and the third reflected electromagnetic wave) of the first and second matrices 110 and 210 can correct the first and second reflection phases by using interference, it is ultimately conducive to achieving the effect of the one-way phase difference between the first and second reflection phases substantially does not change with frequency within a certain frequency range. In other words, by reasonably configuring the first thickness and the second thickness, the change of the one-way phase difference with frequency may be weakened or offset by the coherent superposition between the above reflected electromagnetic waves, and finally it can achieve an effect that there is a large and substantially constant phase difference between the reflected electromagnetic waves of the two transmission units in the target frequency band.

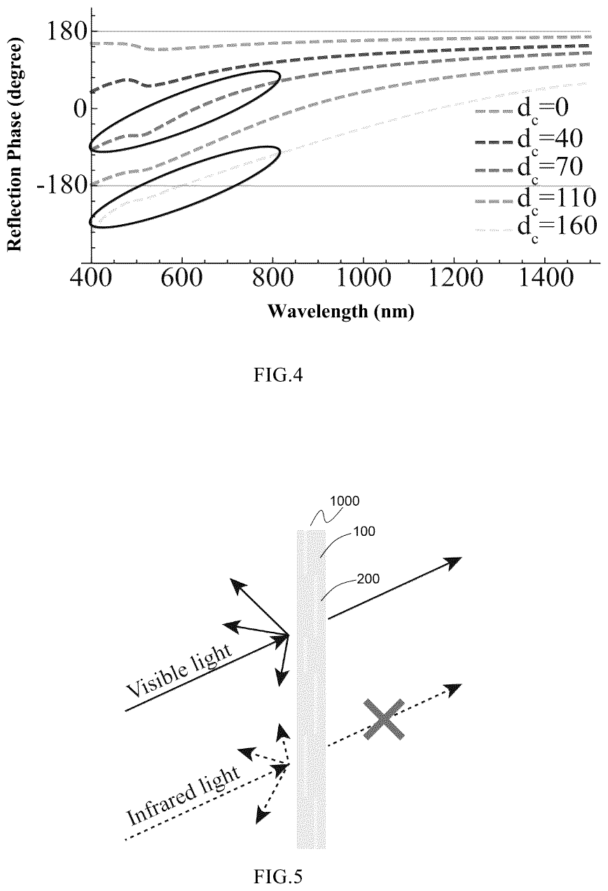

In some implementations, the first thickness and the second thickness may be configured to enable the reflection phase difference between the electromagnetic waves of the first and second transmission units 100 and 200 to satisfy 0.6π≤|φᵣ₁−φᵣ₂|≤1.4π within the preset frequency band and is substantially constant near 0.6π, 0.7π, 0.8π, 0.9π, 1.0π, 1.1π, 1.2π, 1.3π or 1.4π. In this way, it is conducive for the transmission structure 1000 to obviously disperse the energy of reflected electromagnetic waves toward the surroundings in a wide frequency range to achieve effects of forming obvious diffuse reflection by the reflected waves, substantially eliminating the mirror reflection to the surrounding environment, and concentrating the energy of the transmitted waves without substantially disturbing the wavefront of the transmitted waves. Optionally, the reflection phase difference between the electromagnetic waves of the first and second transmission units 100 and 200 is substantially constant as π, which is conducive for the transmission structure 1000 to stably achieve effects of forming obvious diffuse reflection by the reflected waves, substantially eliminating the mirror reflection to the surrounding environment, and concentrating the energy of the transmitted waves without substantially disturbing the wavefront of transmitted waves in a wide frequency range. As shown in FIG. 4, when the first thickness of the first transmission unit 100 is 70 nm and the second thickness of the second transmission unit 200 is 160 nm, the absolute value of the difference between the first reflection phase φᵣ₁ of the reflected electromagnetic wave of the first transmission unit 100 and the second reflection phase φᵣ₂ of the reflected electromagnetic wave of the second transmission unit 200 is within the range of the preset constant π±0.1π, and the wavelength range of the corresponding operating frequency band is 400 nm to 800 nm.

According to the above transmission structure 1000, both of the first thickness and the second thickness are non-zero thicknesses, and the second thickness and the first thickness can correspondingly utilize the interference of reflected electromagnetic waves to make the first and second reflection phases satisfy 0.6π≤|φᵣ₁−φᵣ₂|≤1.4π within the preset frequency band, so that the transmission structure 1000 composed of these two types of transmission units randomly arranged can achieve effects that the reflected waves form obvious diffuse reflection and it can substantially eliminate the mirror reflection of the transmission structure to the surrounding environment in a wide frequency band range. At the same time, the transmission phases of the electromagnetic waves of different transmission units in the above transmission structure 1000 satisfy 0≤|φᵣ₁−φᵣ₂|≤0.5π, so that the wavefront of the transmitted waves is substantially not disturbed, and the transmission structure, in which a material of the matrix is a transparent material, also has low haze. In addition, by adjusting the first thickness and the second thickness to achieve the above effects, it is conducive to reducing the difficulty and complexity for preparing the above transmission structure 1000, thereby helping the preparation of a macro-scale product with the transmission structure.

It can be understood that if a period of 2nπ (n is a non-zero integer) is added to the above transmission phase difference and reflection phase difference respectively, the effect of the transmission structure 1000 will not be affected.

In some implementations, the first thickness is configured to enable the reflection coefficient of the reflected electromagnetic wave of the first transmission unit 100 at a reference frequency to be a real number, and the reference frequency is within the preset frequency band; and the second thickness is configured to enable the first reflection phase φᵣ₁ and the second reflection phase g, to satisfy 0.8π≤|φᵣ₁−φᵣ₂|≤1.2 π at the reference frequency. When an electromagnetic wave is incident from an optically thinner medium to an optically denser medium, a half-wave loss occurs in the reflected electromagnetic wave (that is, the vibration direction of the reflected electromagnetic wave when leaving the reflection point is opposite to the vibration direction of the incident electromagnetic wave when reaching the incident point). Therefore, considering that the background medium is usually an optically thinner medium (such as air), while the first matrix 110 and the second matrix 210 are usually optically denser media (such as silicon, glass, etc.), and thus when the reflected electromagnetic waves on the electromagnetic wave incident surfaces of the first and second matrices 110 and 210 (in which half-wave loss occurs) are mainly considered, it is more conducive to ensuring the achievement of the effect that the first reflection phase φᵣ₁ and the second reflection phase φᵣ₂ satisfy 0.6π≤|φᵣ₁−φᵣ₂|1.4π in a wide frequency range by the above arrangement. It can be understood that, in some other implementations, the second thickness may be configured to enable the reflection coefficient of the second transmission unit 200 at the reference frequency to be a real number, while the first thickness may be configured to enable the first reflection phase φᵣ₁ and the second reflection phase φᵣ₂ to satisfy 0.8π≤|φᵣ₁−φᵣ₂|≤1.2π at the reference frequency. The technical effects corresponding to the above two expressions are the same. For convenience of description, the smaller thickness of the first thickness and the second thickness is taken as the first thickness in each embodiment of the present disclosure.

Optionally, the reference frequency may be selected as the center frequency near the middle (such as one-half) of the expected operating frequency band. For example, the expected operating frequency band is f₁˜f₂, then the reference frequency may be (f₁+f₂)/2 to simplify the calculation and facilitate the control of an actual operating frequency band. On the other hand, since the reflection coefficient is a complex number, it can be known from the expression of the reflection coefficient R(z)=re^{i(φ-βz)} in electromagnetics that “enable the reflection coefficient of the first transmission unit 100 at the reference frequency to be a real number” of the present disclosure means that the reflected phase (i.e., φ−2βz) of the electromagnetic wave of the first transmission unit 100 at the reference frequency is 0 or ±kπ,k is a non-zero integer. It should be pointed out that, in a practical application, considering there is some slight absorption in the material itself, it is usually difficult to make the reflection coefficient of the first transmission unit 100 at the reference frequency completely a pure real number. Therefore, when an imaginary part of the reflection coefficient is extremely small, that is, when it approaches 0 (for example, the value of the imaginary part is less than 0.01, and further less than 0.001), it should still be considered to meet the requirement of the reflection coefficient proposed in the present disclosure.

In addition, according to the formula 2nk₀|d₁−d₂|=ΔΔφ+2mπ, where m is an integer, it can be know that in the structure of the above transmission unit, the change of the difference (|d₁−d₂|) between the second thickness and the first thickness may correspond to the change of the difference (Δφ) between the reflection phases of electromagnetic waves of the first and second transmission units 100 and 200, so that by reasonably configuring the second thickness and the first thickness, the difference between the first reflection phase φᵣ₁ and the second reflection phase φᵣ₂ may satisfy 0.8π≤|φᵣ₁|−φᵣ₂|1.2π at the reference frequency, and thus it is conducive for the transmission structure 1000 to achieve an effect that the first reflection phase φᵣ₁ and the second reflection phase φᵣ₂ satisfy 0.6π≤|φᵣ₁−φᵣ₂|≤1.4π in a wide frequency range near the reference frequency. At the reference frequency, the reflection phase difference between the electromagnetic waves of the two transmission units can be any one of 0.8π, 0.9π, 1.0π, 1.1π, and 1.2π.

Optionally, the first and second matrices 110 and 210 are made of the same material. Optionally, the first and second medium blocks 120 and 220 are made of the same material. Optionally, the first and second medium blocks 120 and 220 have the same thickness. It is conducive to simplifying the determination process of the first and second thicknesses by the above arrangement. As shown in FIG. 4, which shows the changing relationship curve of the reflection phase of the electromagnetic wave of a certain transmission unit versus a thickness (i.e., dc) of a matrix between an embedded layer and an electromagnetic wave incident surface of the transmission unit and the wavelength of the incident electromagnetic wave when the matrix is silicon dioxide, a thickness of the embedded layer is 25 nm, and a material of the embedded layer is gold in the transmission unit. The horizontal axis represents the wavelength of the electromagnetic wave incident on the transmission structure 1000 in nanometers, and the vertical axis represents the phase of the reflected electromagnetic wave in degrees. It can be seen that when the first and second thicknesses are controlled to be 40 nm and 160 nm, respectively, the corresponding wavelength range that satisfies the reflection phase difference of 0.6π to 1.4π (corresponding to 108 degrees to 252 degrees) is 600 nm to 1300 nm, and the corresponding reference frequency is roughly 1150 nm. The second reflection phase of the reflected electromagnetic wave of the second transmission unit 200 is near 0 at the reference frequency, and the reflection coefficient of the reflected electromagnetic wave of the second transmission unit 200 is approximately a real number, meanwhile the absolute value of the difference between the first reflection phase φᵣ₁ and the second reflection phase φᵣ₂ is near 0.8π. When the first and second thicknesses are controlled to be 70 nm and 160 nm, respectively, the corresponding wavelength range that satisfies the reflection phase difference of 0.6π to 1.4π is at least 400 nm to 1140 nm. It can be seen that the reference frequency is roughly 650 nm, the first reflection phase of the reflected electromagnetic wave of the first transmission unit 100 is near 0 at the reference frequency, and the reflection coefficient of the reflected electromagnetic wave of the first transmission unit 100 is approximately a real number, meanwhile the absolute value of the difference between the first reflection phase p, and the second reflection phase φᵣ₁ is near π. Therefore, compared with the prior art, the transmission structure 1000 of the present disclosure is obviously more conducive to having a wider operating frequency band range.

It can also be seen from FIG. 4 that the preset frequency band includes at least part of the visible light frequency band and/or at least part of the infrared light frequency band. It should be pointed out that the range of the visible light frequency band described in the present disclosure includes 400 nm to 760 nm, and the range of the infrared light frequency band described in the present disclosure includes 760 nm to 1 mm. When the preset frequency band includes at least part of the visible light frequency band, the transmission structure 1000 may be used to prepare glass curtain walls of buildings, automobile glass, etc., which is conducive to avoiding the harm of urban light pollution. When the preset frequency band includes at least part of the infrared light frequency band, the transmission structure 1000 can be used for the preparation of an infrared projector.

Further, the second thickness is configured to enable the absolute value of the difference between the first reflection phase φᵣ₁ and the second reflection phase φᵣ₂ to be π at the reference frequency. Similarly, in some other implementations, when the second thickness is configured to enable the reflection coefficient of the reflected electromagnetic wave of the second transmission unit 200 to be a real number at the reference frequency, the first thickness may be correspondingly configured to enable the absolute value of the difference between the first reflection phase φᵣ₁ and the second reflection phase φᵣ₂ to be π at the reference frequency. The technical effects corresponding to the above two expressions are consistent. This is conducive for the transmission structure 1000 to stably achieve effects of forming obvious diffuse reflection by the reflected waves, substantially eliminating mirror reflection to the surrounding environment, and concentrating the energy of the transmitted waves without substantially disturbing the wavefront of the transmitted wavefronts in a wide frequency range. As shown in FIG. 4, when the first thickness is 70 nm and the second thickness is 160 nm, the absolute value of the difference between the first reflection phase φᵣ₁ and the second reflection phase φᵣ₂ is close to π at the reference frequency of 630 nm, and the wavelength range of the corresponding operating frequency band is 400 nm˜800 nm.

In some implementations, the reflectivity R₁ of the first transmission unit 100 and the reflectivity R₂ of the second transmission unit 200 are substantially consistent or the same within the preset frequency band, which is conducive to making the energy distribution of the reflected electromagnetic waves in the space of the reflection side more uniform, and further improves the distribution uniformity of diffusely reflected light. In some implementations, the transmittance T₁ of the first transmission unit 100 and the transmittance T₂ of the second transmission unit 200 are substantially consistent or the same within the preset frequency band, which is conducive to making the energy distribution of the transmitted electromagnetic waves in the space of the transmission side more uniform, and improves transmission imaging quality.

In some implementations, the first thickness d₁ ranges from 30 nm to 120 nm, and the second thickness d₂ ranges from 110 nm to 290 nm. For example, d₁ may be any one of 30 nm, 50 nm, 70 nm, 90 nm, 110 nm, and 120 nm, and d₂ may be any one of 110 nm, 140 nm, 170 nm, 200 nm, 240 nm, 280 nm, and 290 nm. By controlling the first thickness d₁ and the second thickness d₂ to satisfy the above range, it is helpful to form the transmission structure 1000 that meets the reflection phase difference requirements in a wide frequency range of the visible light frequency band and/or the infrared frequency band. Further, the first thickness d₁ ranges from 40 nm to 80 nm, and the second thickness d₂ ranges from 130 nm to 160 nm, which is conducive to controlling the operating frequency band of the transmission structure 1000 within the visible light frequency band range to meet application needs in daily life, such as glass curtain walls, and automotive glass, etc.

In some implementations, the first and second matrices 110 and 210 are made of the same material, and the first and second medium blocks 120 and 220 have the same thickness and are made of the same material. Through the above arrangement, it is conducive to quickly determining the appropriate first and second thicknesses, so that the transmission structure 1000 achieves the effect of forming obvious diffuse reflection by the reflected waves in a wide frequency band, thereby reducing the preparation cost. For example, the first matrix 110 and the second matrix 210 can both be made of glass or solid acetic acid, etc., and the first medium block 120 and the second medium block 220 can both be made of metal or dielectric, etc.

In some implementations, the materials of the first matrix 110 and the second matrix 210 may include at least one of dielectric and semiconductor, for example, may include at least one of silicon (Si), silicon dioxide (SiO2), silicon nitride (SiN), gallium nitride (GaN), titanium dioxide (TiO2), and optical plastics, where the optical plastics may include transparent plastics such as polymethylmethacrylate (PMMA, commonly known as organic glass), polystyrene (PS), polycarbonate (PC), styrene acrylonitrile (AS or SAN), styrene-methyl methacrylate copolymer (MS), poly-4-methyl-1-pentene (trade name: TPX), and transparent polyamide, etc. The materials of the first medium block 120 and the second medium block 220 may include at least one of metal and non-metal, and the non-metal may include at least one of dielectric and semiconductor (such as silicon, graphene, etc.), where, silicon nitride (SiN), gallium nitride (GaN), and titanium dioxide (TiO2) are materials that absorb little light in the visible light band, and silicon (Si) absorbs much light in the visible light band. In this way, the transmission structure 1000 of the present disclosure may be prepared by many common materials in nature, which is conducive to reducing the difficulty of selecting materials for the transmission structure 1000, thereby reducing the preparation cost.

Preferably, when the first and second medium blocks 120 and 220 are made of metal, for example, they may be at least one of copper, silver, gold, aluminum, and platinum, on the one hand, it is conducive to making the above embedded layer maintain a sheet-like structure even when it is processed to be very thin (such as nanometer scale), on the other hand, as shown in FIG. 5, it can effectively suppress the transmittance of electromagnetic waves in the infrared frequency band to isolate thermal radiation in the infrared frequency band and solve the problem of temperature increase caused by the transmission of infrared light. For example, when the first and second matrices 110 and 210 are made of glass, and the first and second medium blocks 120 and 220 are made of metal, the transmission structure 1000 is preferably used to prepare glass curtain walls of buildings or automobile glass, so that it may make a house or vehicle warm in winter and cool in summer in addition to preventing light pollution and not affecting the visibility of people in the house or vehicle.

Optionally, the first and second medium blocks 120 and 220 are made of gold to achieve effects of forming better diffuse reflection by the reflected waves in a wide frequency band, substantially eliminating mirror reflection to the surrounding environment, and concentrating the energy of the transmitted waves without substantially disturbing the wavefront of the transmitted waves. Of course, considering the preparation cost, other metal materials may also be selected, which is not limited in the present disclosure.

It should be pointed out that in some embodiments, the transmittance of the transmission structure 1000 is less than or equal to 50%, so that when compared with unidirectional perspective glass, even if the illumination on both sides of the transmission structure 1000 does not differ greatly, the privacy of people located on one side of the transmission structure 1000 can still be effectively ensured. For example, when the above transmission structure 1000 is applied to side window glass and rear window glass of a vehicle, it is difficult for people outside the vehicle to see the conditions of people inside the vehicle during the day, which may ensure privacy in the vehicle to a certain extent, and meanwhile people inside the vehicle may clearly observe road environment outside through the side window glass and the rear window glass. For another example, when the above transmission structure 1000 is applied to glass curtain walls of a building, it is difficult for people outside the building to see conditions of people in the building during the day, which may ensure the privacy of people in the building, and meanwhile people in the building may clearly observe scenes outside the building through the glass curtain walls, thereby ensuring an unobstructed view inside the building.

Optionally, in some other embodiments, the transmittance of the first transmission unit 100 and the second transmission unit 200 may be appropriately reduced, or a film that increases reflection or a film that reduces transmission may be disposed on an electromagnetic wave incident surface and/or an electromagnetic wave exit surface of the transmission structure, so as to reduce light transmitted by the transmission structure 1000 collected by human eyes outside the house or vehicle and increase light reflected by the transmission structure 1000 collected by the human eyes, thereby ensuring the privacy of people in the house or vehicle. Of course, when the transmission structure 1000 is used to prepare a display screen for displaying goods or corporate images, it is not necessary to adopt the above solution of reducing the transmittance. Therefore, a user can choose to customize transmission structural products that meet the required effects according to the actual situation to meet the application needs of different scenarios.

In some implementations, when the first and second medium blocks 120 and 220 are both made of metal, and both have a preset thickness, where the preset thickness is less than or equal to skin depth of the metal. The skin depth refers to the thickness where most charges are located when the charges propagate in a conductor, and its calculation formula may be expressed as δ=\sqrt{2/(σ₀ωμ₀)}, where δ represents the skin depth, σ₀ represents the conductivity of the conductor, ω represents the frequency of the electromagnetic wave, and μ₀ represents the vacuum permeability. In the frequency band of the visible light, the skin depth of a typical metal is about 100 nm. When the preset thickness of the metal is less than the skin depth under its operating frequency band, the electromagnetic wave may be transmitted through the metal and has a certain transmittance.

Further, the thickness of the first medium block 120 ranges from 10 nm to 100 nm, and the thickness of the second medium block 220 ranges from 10 nm to 100 nm. For example, the thickness of the first medium block 120 and the thickness of the second medium block 220 may be 10 nm, 20 nm, 40 nm, 60 nm, 80 nm, or 100 nm. By controlling the thickness of the first medium block 120 and the thickness of the second medium block 220 to satisfy the above range, it is conducive to obtaining a balance among ensuring the isolation of infrared thermal radiation, reducing preparation difficulty, and guaranteeing a certain electromagnetic wave transmittance. When the thickness is less than 10 nm, quantum effects may exist during preparation, which increases the difficulty in preparing the transmission structure 1000, and the effect of isolating infrared thermal radiation will also become worse. When the thickness is greater than 100 nm, the electromagnetic wave transmittance of the transmission structure 1000 may be easily reduced, and be close to 0.

In some implementations, the transmission structure 1000 further includes at least one protective layer (not shown), which may be disposed on the electromagnetic wave incident surface and/or the electromagnetic wave exit surface of the transmission structure 1000. By disposing the protective layer, it is conducive to protecting the transmission structure 1000, thereby preventing the transmission structure 1000 from being damaged by external forces to a certain extent.

Specific embodiments of transmission structures applicable to the above implementations will be further described below with reference to the accompanying drawings.

### Specific Embodiment 1

The transmission structure 1000 according to the embodiment 1 of the present disclosure is described below with reference to FIGS. 2 to 12.

FIG. 2 shows a schematic structural diagram of the two transmission units in the transmission structure 1000, and FIG. 3 shows a schematic diagram of the arrangement of the two transmission units. It can be seen that first and second transmission units 100 and 200 are arranged randomly on a surface, where the first transmission unit 100 has an electromagnetic wave incident surface P1 and the second transmission unit 200 has an electromagnetic wave incident surface P2. The first transmission unit 100 is disposed with a first medium block 120, and a thickness of a first matrix 110 between a top surface of the first medium block 120 and the electromagnetic wave incident surface P1 is a non-zero first thickness d₁. The second transmission unit 200 is disposed with a second medium block 220, and a thickness of the second matrix 210 between a top surface of the second medium block 220 and the electromagnetic wave incident surface P2 is a non-zero second thickness d₂, and the second thickness d₂ is different from the first thickness d₁.

In this embodiment, the first matrix 110 and the second matrix 210 are both made of glass (silicon dioxide, SiO2), and the first medium block 120 and the second medium block 220 are both made of gold (Au), and both have a thickness of 25 nm. Therefore, it can be seen from FIG. 4 that when the first thickness d₁ is 70 nm and the second thickness d₂ is 160 nm, by the first transmission unit 100 and the second transmission unit 200, the absolute value of a phase difference between the reflected light of visible light with a wavelength in the range of 400 nm to 750 nm may be close to π, such as within the range of π±0.1π, so that the transmission structure 1000 achieves effects of forming better diffuse reflection by the reflected waves, substantially eliminating the mirror reflection to the surrounding environment, and concentrating the energy of the transmitted waves without substantially disturbing the wavefront of the transmitted waves in a wide frequency range. In this embodiment, the reference frequency is roughly 630 nm. In this embodiment, the mirror reflectivity of the transmission structure 1000 to the surrounding environment may be reduced to less than or equal to 1%.

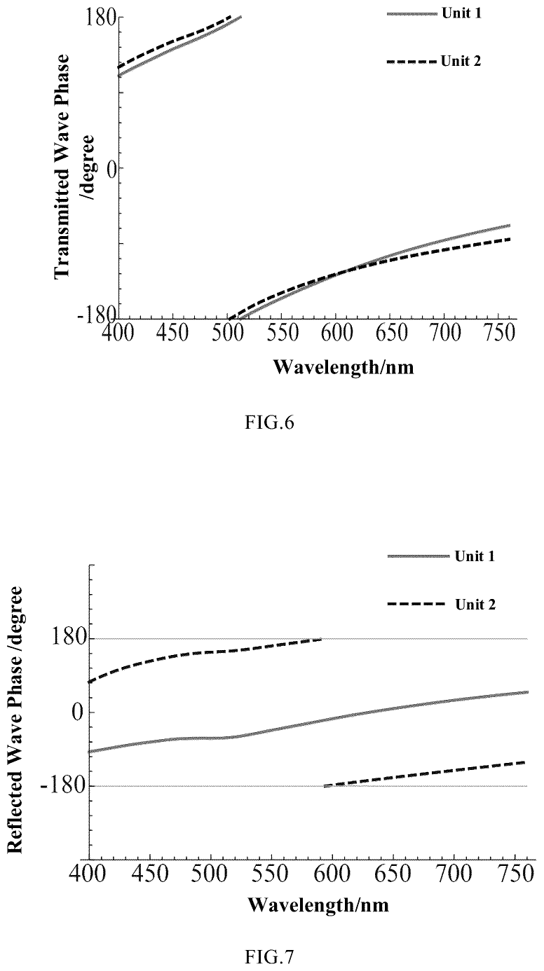

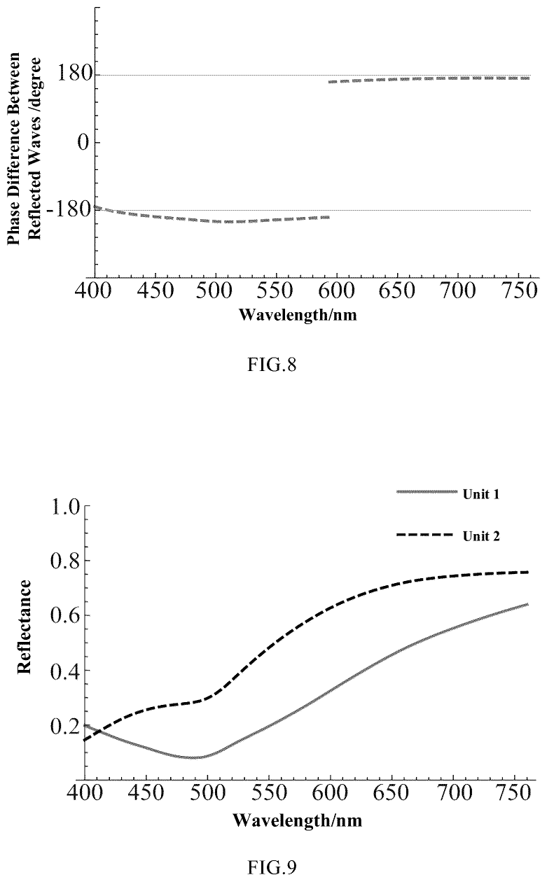

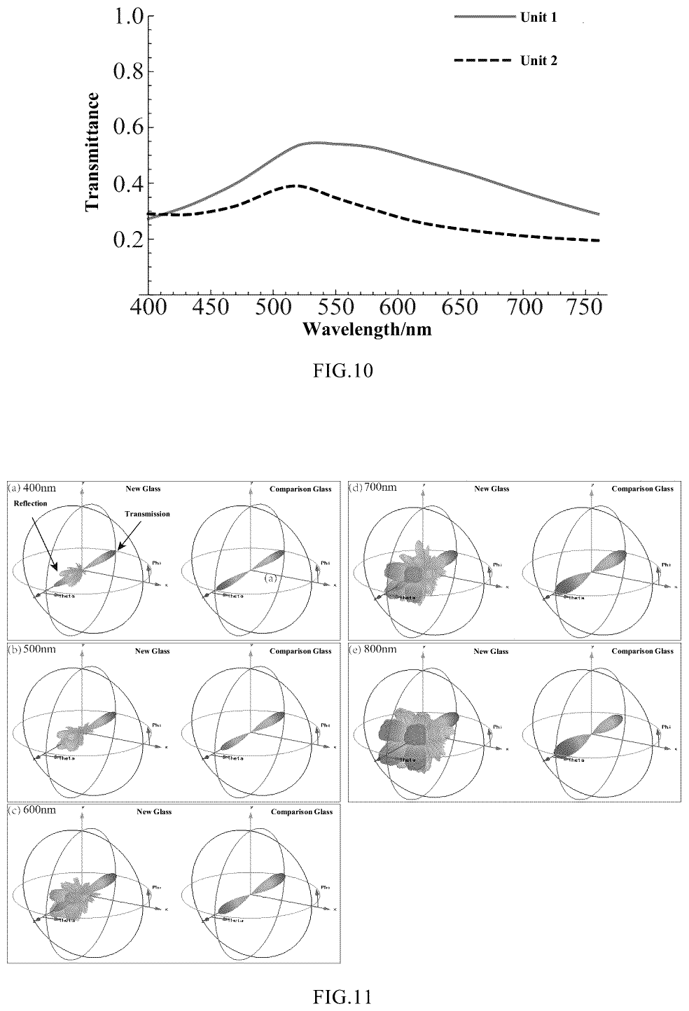

Further, FIGS. 6 to 10 of the present disclosure respectively show a transmission phase diagram, a reflection phase diagram, a reflection phase difference diagram, a reflectance diagram and a transmittance diagram of electromagnetic waves of the first and second transmission units 100 and 200 when the first thickness d₁ is 70 nm and the second thickness d₂ is 160 nm in this embodiment. As shown in FIG. 6, the transmission phases of the electromagnetic waves of the first transmission unit 100 (solid line) and the second transmission unit 200 (dashed line) are the same or similar in the visible light frequency band, with a maximum difference of about 18°. As shown in FIGS. 7 and 8, the difference between the reflection phases of the electromagnetic waves of the first and second transmission units 100 and 200 is close to 180° or −180° in the visible light frequency band. As shown in FIG. 9, reflectances of the first and second transmission units 100 and 200 are relatively close to each other in the visible light frequency band, and the maximum difference between the reflectances is about 20%. As shown in FIG. 10, transmittances of the first and second transmission units 100 and 200 are also relatively close to each other in the visible light frequency band, and the maximum difference between the transmittances is also about 20%.

Further, FIGS. (a) to (e) of FIG. 11 of the present disclosure also show far-field energy distribution diagrams when electromagnetic waves with wavelengths of 400 nm, 500 nm, 600 nm, 700 nm and 800 nm are respectively incident on the transmission structure 1000 (i.e., the new glass in FIG. 11) of this embodiment, in which the first transmission unit 100 and the second transmission unit 200 are arranged on the x-y plane, and the electromagnetic waves are incident on the transmission structure 1000 along the −z direction. It can be seen that the electromagnetic waves with various wavelengths are diffusely reflected on the electromagnetic wave incident surface of the transmission structure 1000, and the reflected electromagnetic waves are dispersed in various directions on the reflective side of the transmission structure 1000, while the transmitted electromagnetic waves retain the wavefront of the incident electromagnetic waves on the transmission side of the transmission structure 1000, so that the energy of the transmitted electromagnetic waves is still concentrated in the main direction of −z, that is, the propagation direction of the incident electromagnetic waves is maintained.

As a comparison, FIG. 11 also shows far-field energy distribution diagrams when electromagnetic waves with wavelengths of 400 nm, 500 nm, 600 nm, 700 nm and 800 nm are incident on uniform glass (i.e., the comparison glass in FIG. 11). It can be seen that electromagnetic waves with various wavelengths occur mirror reflection on the electromagnetic wave incident surface of the uniform glass, and the energy of the reflected electromagnetic waves is concentrated in the z direction on the reflection side of the uniform glass, while the transmitted electromagnetic waves retain the wavefront of incident electromagnetic waves on the transmission side of the transmission structure 1000, so that the energy of the transmitted electromagnetic waves is still concentrated in the main direction of −z, that is, the propagation direction of the incident electromagnetic waves is maintained.

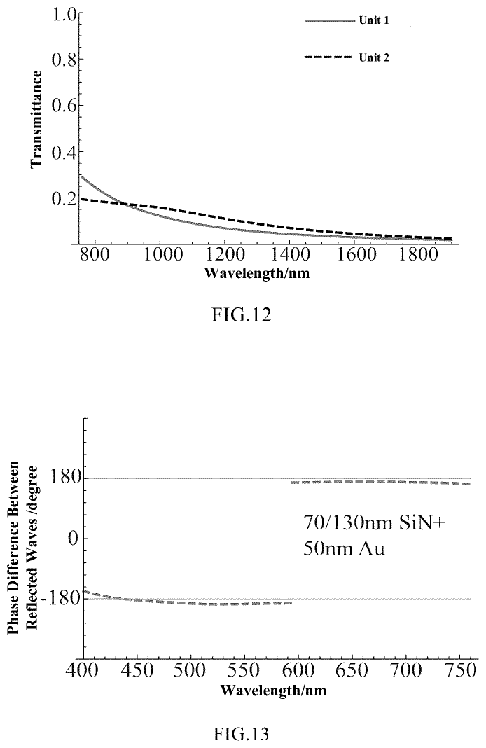

On the other hand, since the first and second medium blocks 120 and 220 of this embodiment are both made of metal gold, the transmittance of an electromagnetic wave in the infrared frequency band may be effectively suppressed and the thermal radiation in the infrared frequency band may be isolated, as shown in FIG. 5. Specifically, FIG. 12 shows the changing curve of the transmittance versus the wavelength when the electromagnetic waves are incident on the first transmission unit 100 (solid line) and the second transmission unit 200 (dashed line). It can be seen that the highest transmittance of the electromagnetic waves in the infrared frequency band is less than 30%, and as the wavelength increases, the transmittance of the electromagnetic waves gradually decreases, and eventually approaches 0. In the prior art, such as the transmission structure 600 in the aforementioned patent with Publication No. CN110854539B, even if a material of each embedded block is also metal, the transmittance of light in the infrared light band is still higher than 80%, and the heat insulation effect is poor.

### Specific Embodiment 2

The transmission structure 1000 according to the embodiment 2 of the present disclosure is described below with reference to FIG. 13. In this embodiment, for the sake of simplicity, some descriptions similar to those in the embodiment 1 will be omitted.

In this embodiment, the first and second matrices 110 and 210 are both made of a silicon nitride material (SiN), the first and second medium blocks 120 and 220 are both made of gold (Au), and both have a thickness of 50 nm. It can be seen from FIG. 13 that when the first thickness d₁ is 70 nm and the second thickness d₂ is 130 nm, the absolute value of the phase difference of the reflected light of visible light with a wavelength in the range of 400 nm to 750 nm may be close to π, such as within the range of π±0.1π, by the first and second transmission units 100 and 200, so that the transmission structure 1000 achieves effects of forming better diffuse reflection by the reflected waves, substantially eliminating the mirror reflection to the surrounding environment, and concentrating the energy of the transmitted waves without substantially disturbing the wavefront of the transmitted waves in a wide frequency band range. In this embodiment, the reference frequency is roughly 650 nm.

### Specific Embodiment 3

The transmission structure 1000 according to the embodiment 3 of the present disclosure is described below with reference to FIG. 14. In this embodiment, for the sake of simplicity, some descriptions similar to those in the embodiment 1 will be omitted.

In this embodiment, the first and second matrices 110 and 210 are both made of glass (silicon dioxide, SiO2), the first and second medium blocks 120 and 220 are both made of silicon (Si), and both have a thickness of 25 nm. It can be seen from FIG. 14 that when the first thickness d₁ is 80 nm and the second thickness d₂ is 160 nm, the absolute value of the phase difference of the reflected light of visible light with a wavelength in the range of 400 nm to 750 nm is close to π, such as within the range of π±0.1π, by the first and second transmission units 100 and 200, so that the transmission structure 1000 achieves effects of forming better diffuse reflection by the reflected waves, substantially eliminating the mirror reflection to the surrounding environment, and concentrating the energy of the transmitted waves without substantially disturbing the wavefront of the transmitted waves in a wide frequency band range. In this embodiment, the reference frequency is roughly 600 nm. At this time, the second reflection phase may be near −π, and the reflection coefficient of the reflected electromagnetic wave of the second transmission unit 200 is a real number.

### Specific Embodiment 4

The transmission structure 1000 according to the embodiment 4 of the present disclosure is described below with reference to FIG. 15. In this embodiment, for the sake of simplicity, some descriptions similar to those in the embodiment 1 will be omitted.

In this embodiment, the first and second matrices 110 and 210 are both made of glass (silicon dioxide, SiO2), and the first and second medium blocks 120 and 220 are both made of gold (Au), and both have a thickness of 25 nm. It can be seen from FIG. 15 that when the first thickness d₁ is 120 nm and the second thickness d₂ is 290 nm, the absolute value of the phase difference of the reflected light of visible light with a wavelength in the range of 800 nm to 1500 nm may be close to π, such as within the range of π±0.1π, by the first and second transmission units 100 and 200, so that the transmission structure 1000 achieves effects of forming better diffuse reflection by the reflected waves, substantially eliminating the mirror reflection to the surrounding environment, and concentrating the energy of the transmitted waves without substantially disturbing the wavefront of the transmitted waves in a wide frequency band range. In this embodiment, the reference frequency is roughly 1000 nm.

The present disclosure also provides a preparation method of the above transmission structure 1000. Specifically, the preparation method includes:

S110, determining a reference frequency according to an operating frequency band of the transmission structure, and the reference frequency is within the operating frequency band.

The reference frequency may be selected as a frequency near the middle (such as one-half) of an expected operating frequency band. For example, the expected operating frequency band is f₁˜f₂, then the reference frequency may be (f₁+f₂)/2, to simplify the calculation and facilitate the control of the actual operating frequency band.

S120, providing a plurality of first transmission units. The first transmission unit has a first matrix, in which a first medium block is disposed. A thickness of the matrix between the first medium block and the electromagnetic wave incident surface of the first transmission unit is a non-zero first thickness. The first thickness is configured to enable the reflection coefficient of the reflected electromagnetic wave of the first transmission unit at the reference frequency to be a real number.

S130, providing a plurality of second transmission units. The second transmission unit has a second matrix, in which a second medium block is disposed. A thickness of the matrix between the second medium block and the electromagnetic wave incident surface of the second transmission unit is a non-zero second thickness, and the second thickness is different from the first thickness.

When electromagnetic waves are incident on the first and second transmission units, the transmitted electromagnetic wave of the first transmission unit has a first transmission phase φᵣ₁, the transmitted electromagnetic wave of the second transmission unit has a second transmission phase φᵣ₂, and the first transmission phase φᵣ₁ and the second transmission phase φᵣ₂ satisfy 0≤|φᵣ₁−φᵣ₂|≤0.5π within the preset frequency band. The first thickness is configured to enable the reflected electromagnetic wave of the first transmission unit to have a first reflection phase φᵣ₁ at least through the interference of the reflected electromagnetic waves of the first matrix and the first medium block, and the second thickness is configured to enable the reflected electromagnetic wave of the second transmission unit to have a second reflection phase φᵣ₂ at least through the interference of the reflected electromagnetic waves of the second matrix and the second medium block. The first reflection phase φᵣ₁ and the second reflection phase φᵣ₂ satisfy 0.8π≤|φᵣ₁−φᵣ₂|≤−1.2π at the reference frequency.

S140, randomly arranging the plurality of first transmission units and the plurality of second transmission units on a surface, and jointly forming an electromagnetic wave incident surface of the transmission structure by electromagnetic wave incident surfaces of the plurality of first transmission units and electromagnetic wave incident surfaces of the plurality of second transmission units.

In the above preparation method of the transmission structure, by reasonably configuring the non-zero first and second thicknesses, the first reflection phase φᵣ₁ and the second reflection phase φᵣ₂ may satisfy 0.6π≤|φᵣ₁−φᵣ₂|≤1.4π within the preset frequency band by correspondingly utilizing the interference of electromagnetic waves, and thus the transmission structure obtained by randomly arranging the first and second transmission units can achieve the effect that the reflected waves form obvious diffuse reflection in a wide frequency band range, and it can substantially eliminate the mirror reflection of the transmission structure to the surrounding environment. At the same time, since the transmission phases of the electromagnetic waves of different transmission units satisfy 0≤|φᵣ₁−φᵣ₂|≤0.5π, the wavefront of the transmitted waves may be substantially not disturbed, and the transmission structure, in which the material of the matrix is a transparent material, also has low haze. In addition, by adjusting the first and second thicknesses to achieve the above effects, it is conducive to reducing the difficulty and complexity of preparing the above transmission structure, thereby helping the preparation of a macro-scale product with the transmission structure.

In some implementations, the above method further includes: further adjusting the second thickness, so that the absolute value of the difference between the first reflection phase φᵣ₁ and the second reflection phase φᵣ₂ is π at the reference frequency.

In some implementations, the preset frequency band includes at least part of the visible light frequency band and/or at least part of the infrared light frequency band.

In some implementations, the first thickness d₁ ranges from 30 nm to 120 nm, and the second thickness d₂ ranges from 110 nm to 290 nm.

In some implementations, the first thickness d₁ ranges from 40 nm to 80 nm, and the second thickness d₂ ranges from 130 nm to 160 nm.

The effects of the above implementations are substantially consistent with that described in the transmission structure 1000 described above, and will not be described repeatedly here.

The present disclosure also provides another transmission structure, which may refer to the transmission structure 2000 in FIG. 19, including: a matrix having an electromagnetic wave incident surface, and including a plurality of first transmission portions and a plurality of second transmission portions randomly distributed. A first medium block is disposed in each first transmission portion to form a first transmission unit, and a thickness of the matrix between the first medium block and the electromagnetic wave incident surface is a non-zero first thickness; a second medium block is disposed in each second transmission part to form a second transmission unit, and a thickness of the matrix between the second medium block and the electromagnetic wave incident surface is a non-zero second thickness, which is different from the first thickness.

When electromagnetic waves are incident on the first and second transmission units,
the transmitted electromagnetic wave of the first transmission unit has a first transmission phase φᵣ₁, and the transmitted electromagnetic wave of the second transmission unit has a second transmission phase φᵣ₂; the first transmission phase φᵣ₁ and the second transmission phase φᵣ₂ satisfy 0≤|(φ^{r1}−φᵣ₂|≤0.5π within a preset frequency band;
the reflected electromagnetic wave of the first transmission portion is a first reflected electromagnetic wave, and the reflected electromagnetic wave of the first medium block is a second reflected electromagnetic wave; the first thickness is configured to cause the reflected electromagnetic wave of the first transmission unit to have a first reflection phase φᵣ₁ at least through the interference of the first reflected electromagnetic wave and the second reflected electromagnetic wave; the reflected electromagnetic wave of the second transmission portion is a third reflected electromagnetic wave, and the reflected electromagnetic wave of the second medium block is a fourth electromagnetic wave; the second thickness is configured to cause the reflected electromagnetic wave of the second transmission unit to have a second reflection phase φᵣ₂ at least through the interference of the third reflected electromagnetic wave and the fourth reflected electromagnetic wave; and the first reflection phase φᵣ₁ and the second reflection phase φᵣ₂ satisfy 0.6π≤|φᵣ₁−φᵣ₂|≤1.4π within the preset frequency band.

The above transmission structure has the randomly distributed first and second transmission portions, and the first thickness of the first medium block and the second thickness of the second medium block are different and both are a non-zero thickness. By reasonably configuring the first and second thicknesses, the first reflection phase φᵣ₁ and the second reflection phase φᵣ₂ satisfy 0.6π≤|φᵣ₁−φᵣ₂|≤1.4π within the preset frequency band by correspondingly utilizing the interference of the electromagnetic waves, so that the above transmission structure can achieve the effect that the reflected waves form obvious diffuse reflection in a wide frequency band range, and it substantially eliminates the mirror reflection of the transmission structure to the surrounding environment. At the same time, the transmission phases of the electromagnetic waves of different transmission units in the above transmission structure satisfy 0≤|φᵣ₁−φᵣ₂|≤0.5π, so that the wavefront of the transmitted waves is substantially not disturbed, and the transmission structure, in which the material of the matrix is a transparent material, also has lower haze. In addition, by adjusting the first thickness and the second thickness to achieve the above effects, it is conducive to reducing the difficulty and complexity of preparing the above transmission structure, thereby helping the preparation of a macro-scale product with the transmission structure.

In some implementations, the first thickness is configured such that the reflection coefficient of the reflected electromagnetic wave of the first transmission unit at the reference frequency is a real number, and the reference frequency is within the preset frequency band; and the second thickness is configured such that the first reflection phase φᵣ₁ and the second reflection phase φᵣ₂ satisfy 0.8π≤|φᵣ₁−φᵣ₂|≤1.2π at the reference frequency.

In some implementations, the second thickness is configured to enable the absolute value of the difference between the first reflection phase φᵣ₁ and the second reflection phase φᵣ₂ to be π at the reference frequency.

In some implementations, the preset frequency band includes at least part of the visible light frequency band and/or at least part of the infrared light frequency band.

In some implementations, the first thickness d₁ ranges from 30 nm to 120 nm, and the second thickness d₂ ranges from 110 nm to 290 nm.

In some implementations, the first thickness d₁ ranges from 40 nm to 80 nm, and the second thickness d₂ ranges from 130 nm to 160 nm.

In some implementations, the material of the matrix may include at least one of dielectric and semiconductor, for example, it may include at least one of silicon (Si), silicon dioxide (SiO2), silicon nitride (SiN), gallium nitride (GaN), titanium dioxide (TiO2), and optical plastics. The materials of the first and second medium blocks may both include at least one of metal, dielectric, and semiconductor. For example, they may include at least one of copper, silver, gold, aluminum, platinum, silicon and graphene.

The effects of the transmission structure in the above embodiment are the same as those described in the aforementioned transmission structure 1000, and will not be described repeatedly here.

The present disclosure also provides a preparation method of the transmission structure 2000, as shown in FIG. 19. The preparation method includes:

S210, providing a first substrate 50. The first substrate 50 has an electromagnetic wave incident surface P, and includes a plurality of first transmission areas 300′ (the 1st, 4th, 5th, and 7th small blocks from the left) and a plurality of second transmission areas 400′ (the 2nd, 3rd, and 6th small blocks from the left).

S220, forming a patterned first medium layer on the first substrate 50. The patterned first medium layer includes a plurality of first medium blocks 320, each first medium blocks 320 and each first transmission areas 300′ are in one-to-one correspondence, and the thickness of the first substrate 50 between the first medium block 320 and the electromagnetic wave incident surface P is a first thickness d₁.

That is, the first medium block 320 is formed on a side of each first transmission area 300′ away from the electromagnetic wave incident surface P. Specifically, a first medium material layer 320′ may be deposited through a deposition process, and then be etched using a mask and photoresist to form the patterned first medium layer on the side of the first substrate 50 away from the electromagnetic wave incident surface P.

S230, forming a second substrate 60 on the first substrate 50 and the patterned first medium layer. The second substrate 60 and the first substrate 50 are made of the same material.

Specifically, the second substrate 60 may also be formed on a side of the first substrate 50 and the patterned first medium layer away from the electromagnetic wave incident surface P through the deposition process.

S240, forming a patterned second medium layer on the second substrate 60. The patterned second medium layer includes a plurality of second medium blocks 420, each second medium block 420 and each second transmission area 400′ are in one-to-one correspondence, and the thickness of the first and second substrates 50 and 60 between the second medium block 420 and the electromagnetic wave incident surface P is a second thickness d₂.

That is, the second medium block 420 is formed on the side of a portion of the second substrate 60 corresponding to each second transmission portion 400′ that is away from the electromagnetic wave incident surface P. Specifically, a second medium material layer 420′ may also be deposited through the deposition process, and then be etched using a mask and photoresist to form the patterned second medium layer on the side of the second substrate 60 away from the electromagnetic wave incident surface P.

S250, forming a third substrate 70 on the second substrate 60 and the patterned second medium layer. The third substrate 70 and the second substrate 60 are made of the same material.

Specifically, the third substrate 70 may also be formed on a side of the second substrate 60 and the patterned second medium layer away from the electromagnetic wave incident surface P through the deposition process. By forming the third substrate 70, it is conducive to flattening a surface of the transmission structure 200, thereby facilitating engineering adaptation and application.

Along the normal direction of the electromagnetic wave incident surface P, the first and second medium blocks 320 and 420 have first and second projections on the electromagnetic wave incident surface P, respectively, and the first projection does not overlap the second projection. The first transmission portion 300′, and the first medium block 320, a portion of the second substrate 60, and a portion of the third substrate 70 corresponding to the first transmission portion 300′ can form the first transmission unit 300, and the second transmission portion 400′, and a portion of the second substrate 60, the second medium block 420, and a portion of the third substrate 70 corresponding to the second transmission portion 400′ may form the second transmission unit 400.

Moreover, when the electromagnetic waves are incident on the first and second transmission units 300 and 400, the transmitted electromagnetic wave of the first transmission unit has a first transmission phase φᵣ₁, the transmitted electromagnetic wave of the second transmission unit has a second transmission phase φᵣ₂, and the first transmission phase φᵣ₁ and the second transmission phase φᵣ₂ satisfy 0≤|φᵣ₁−φᵣ₂|≤0.5π within the preset frequency band. The first thickness d₁ is configured such that the reflected electromagnetic wave of the first transmission unit 300 has a first reflection phase φᵣ₁ at least through the interference of the reflected electromagnetic waves of the electromagnetic wave incident surface P and the first medium block 320, and the second thickness is configured such that the reflected electromagnetic wave of the second transmission unit 400 has the second reflection phase φᵣ₂ at least through the interference of the reflected electromagnetic waves of the electromagnetic wave incident surface P and the second medium block 420. The first reflection phase φ^{r1} and the second reflection phase φᵣ₂ satisfy 0.6π|φᵣ₁−φᵣ₂|1.4π within the preset frequency band.

Finally, the transmission structure 2000 that can achieve the following effects in a wide frequency band may be formed: the wavefront of the transmitted waves is substantially not disturbed, the reflected waves form obvious diffuse reflection, and the mirror reflection to the surrounding environment is substantially eliminated.

The phase conditions in the above preparation method may be satisfied through simulation and experimental testing. The disposing of the medium layer and the control of thickness may be performed by deposition and photolithography processes on the substrate, the substrate can be made of glass, and the material of the two medium layers may both be metal (such as gold, silver, aluminum, etc.), thereby facilitating the preparation of the transmission structure 2000.

In some implementations, the thickness of the first substrate 50 ranges from 30 nm to 120 nm in the first transmission unit 300, and the total thickness of the first and second substrates 50 and 60 ranges from 110 nm to 290 nm in the second transmission unit.

In some implementations, the thickness of the first substrate 50 ranges from 40 nm to 80 nm in the first transmission unit 300, and the total thickness of the first and second substrates 50 and 60 ranges from 130 nm to 160 nm in the second transmission unit.

The effects on the transmission structure 2000 in the above implementations are the same as those described in the aforementioned transmission structure 1000, and will not be described repeatedly here.

The present disclosure also provides another preparation method of the transmission structure 2000 (not shown). The preparation method includes: providing a first substrate with an electromagnetic wave incident surface; forming a photoresist layer with a first pattern on the first substrate, where the photoresist layer with the first pattern includes a plurality of first medium holes, and a portion of the first substrate corresponding to the first medium holes is the first transmission area; forming first medium blocks in the first medium holes; removing at least the photoresist layer with the first pattern; forming a patterned first medium layer by a plurality of the first medium blocks on the first substrate; forming a second substrate on the first substrate and the patterned first medium layer; forming a photoresist layer with a second pattern on the second substrate, where the photoresist layer with the second pattern includes a plurality of second medium holes, and a portion of the first substrate corresponding to the second medium holes is the second transmission area; forming second medium blocks in the second medium holes, where the first and second medium blocks respectively have first and second projections on the electromagnetic wave incident surface in a direction perpendicular to the electromagnetic wave incident surface, the first and second projections are distributed randomly, and the first projection does not overlap the second projection; removing at least the photoresist layer with the second pattern; forming a patterned second medium layer by a plurality of the second medium blocks on the second substrate; and forming a third substrate on the second substrate and the patterned second medium layer.

The first, second and third substrates are made of the same material, the first transmission area and at least the first medium block, a portion of the second substrate part, and a portion of the third substrate corresponding to the first transmission area form the first transmission unit, and the second transmission area and at least a portion of the second substrate, the second medium block, and a portion of the third substrate corresponding to the second transmission area form the second transmission unit.

Optionally, when forming the patterned first medium layer, a first medium material layer may be deposited on the photoresist layer with the first pattern and the first transmission area, so that the first medium material layer in the first medium holes forms the first medium blocks. The shape of the first medium block may be determined by the shape of the first medium hole. For example, the first medium hole may be a circular hole, a square hole, or a triangular hole. Correspondingly, the first medium block may be a circular medium block, a square medium block, or a triangular medium block. Further, when removing the photoresist layer, the first medium material layer higher than the photoresist layer may be removed through a grinding process, and then the photoresist layer may be removed through a corresponding process and solvents. In some other implementations, the photoresist layer and the first medium material layer on the photoresist layer may be removed simultaneously to simplify the removing step.

Optionally, when forming the patterned second medium layer, a second medium material layer may be first deposited on the photoresist layer with the second pattern and the second transmission area, so that the second medium material layer in the second medium holes forms second medium blocks. The shape of the second medium block may be determined by the shape of the second medium hole. For example, the second medium hole may be a circular hole, a square hole, or a triangular hole. Correspondingly, the second medium block may be a circular medium block, a square medium block, or a triangular medium block. Further, when removing the photoresist layer, the second medium material layer higher than the photoresist layer may also be removed through the grinding process, and then the photoresist layer may be removed through a corresponding process and solvents. In some other implementations, the photoresist layer and the second medium material layer on the photoresist layer may be removed simultaneously to simplify the removing step.

In the above preparation method of the transmission structure, deposition and etching processes may be used to prepare the transmission structure described above, and the above preparation method is conducive to reasonably and conveniently configuring the first thickness, the second thickness, and thicknesses of the first and second medium blocks, so that the first reflection phase φᵣ₁ and the second reflection phase φᵣ₂ satisfy 0.6π≤|φᵣ₁−φᵣ₂|1.4π within the preset frequency band by correspondingly utilizing the interference of the electromagnetic waves, and thus the transmission structure obtained by the randomly distributed first and second transmission units can achieve the effect that the reflected waves form obvious diffuse reflection in a wide frequency band range, and it substantially eliminates the mirror reflection of the transmission structure to the surrounding environment. At the same time, the transmission phases of the electromagnetic waves of different transmission units satisfy 0≤|φᵣ₁−φᵣ₂|≤0.5π, so that the wavefront of the transmitted waves are substantially not disturbed, and the transmission structure, in which the material of the matrix is a transparent material, also has lower haze.

The present disclosure also provides another preparation method of the transmission structure 2000 (not shown). The preparation method includes: providing a first substrate with an electromagnetic wave incident surface; forming a plurality of first medium grooves on the first substrate, where a portion of the first substrate corresponding to the first medium grooves is the first transmission area; forming first medium blocks in the first medium grooves; forming a second substrate on the first substrate and the first medium blocks; forming a plurality of second medium grooves on the second substrate, where a portion of the first substrate corresponding to the second medium grooves is the second transmission area; forming second medium blocks in the second medium grooves, where the first and second medium blocks respectively have first and second projections on the electromagnetic wave incident surface in the direction perpendicular to the electromagnetic wave incident surface, the first and second projections are distributed randomly, and the first projection does not overlap the second projection; and forming a third substrate on the second substrate and the second medium blocks.

The first, second and third substrates are made of the same material, the first transmission area and at least the first medium block, a portion of the second substrate part, and a portion of the third substrate corresponding to the first transmission area form the first transmission unit, and the second transmission area and at least a portion of the second substrate, the second medium block, and a portion of the third substrate corresponding to the second transmission area form the second transmission unit.

In the above preparation method of the transmission structure, deposition and etching processes may be used to prepare the transmission structure described above, and the above preparation method is conducive to reasonably and conveniently configuring the first thickness, the second thickness, and thicknesses of the first and second medium blocks, so that the first reflection phase φᵣ₁ and the and second reflection phase φᵣ₂ satisfy 0.6π≤|φᵣ₁−φᵣ₂|≤1.4π within the preset frequency band by correspondingly utilizing the interference of the electromagnetic waves, so that the transmission structure obtained by the randomly distributed first and second transmission units can achieve the effect that the reflected waves form obvious diffuse reflection in a wide frequency band range, and it substantially eliminates the mirror reflection of the transmission structure to the surrounding environment. At the same time, the transmission phases of the electromagnetic waves of the first and second transmission units satisfy 0≤|φᵣ₁−φᵣ₂|0.5π, so that the wavefront of the transmitted waves are substantially not disturbed, and the transmission structure, in which the material of the matrix is a transparent material, also has lower haze.

It should be pointed out that when the operating frequency band of the transmission structure is in the visible light or near infrared frequency band, since the size of the transmission structure is substantially in the nanometer or micron level, the aforementioned photolithography process is usually used to prepare the transmission structure in order to ensure product quality. When the operating frequency band of the transmission structure is in the far infrared or microwave frequency band, since the size of the transmission structure becomes large, for example, it may be in the millimeter or centimeter level, a printed circuit may also be used to prepare the transmission structure in order to balance product quality and preparation cost. Therefore, technicians can select an appropriate preparation method according to various factors such as process conditions, cost, product quality, etc., which is not limited in the present disclosure.

In real life, people may see the mirror image of an object through a smooth surface. This is due to the fact mirror reflection occurs when the light emitted/reflected by the object is irradiated on the smooth surface. After the light carrying the object information by mirror reflection enter human eyes, people may observe a virtual image of the object at the mirror position of the object. For rough surfaces, or random surfaces in the transmission structure proposed by the Chinese invention patent with Publication No. CN110854539B, the situation is completely different. Diffuse reflection occurs when the light emitted/reflected by an object is irradiated on a rough/random surface. That is, the reflected light is scattered randomly to all directions of the space in the reflection side. At the same time, the object information carried by the reflected light is also lost, so diffuse light information entered the retina of the human eyes is messy, and thus when the human eyes focus on the mirror image position of the object, he/she cannot see a complete and/or clear virtual image of the object. However, when the human eyes focus on the rough surface, he/she may see the rough surface, e.g., the human eyes cannot see the mirror image of an object in front of the frosted glass (the object is on the same side of the frosted glass as the human eyes), but he/she can see the frosted glass. At this time, when an external image is projected onto the rough surface, the human eyes can see the real image formed by the external image on the rough surface.

Therefore, on the one hand, a mirror image (virtual image) of an object cannot be formed through diffuse reflection; on the other hand, diffuse reflection can be used for forming an image (real image) through projection. Taking a curtain of a movie theater as an example, the curtain has a rough projection surface, the projector projects light carrying image information onto the curtain, so that the curtain is illuminated. Different locations on the curtain surface display different colors and brightness, so that an image is formed across the entire curtain. Moreover, due to the diffuse reflection of light on the illuminated curtain, viewers located in all directions on the reflection side of the curtain can clearly see the image on the projection surface of the curtain. Therefore, by utilizing the following functions of the transmission structure with a wide operating frequency band of the present disclosure: the wavefront of the transmitted waves is substantially not disturbed, the reflected waves form obvious diffuse reflection, and the mirror reflection to the surrounding environment is substantially eliminated, it can prepare an apparatus that forms an image through projection without disturbing the wavefront of the transmitted waves.

A plurality of application examples based on the function of the transmission structure of the present disclosure will be introduced below. It should be understood that the plurality of examples here are only to facilitate those skilled in the art to understand the technical effects of the transmission structure of the present disclosure, and do not limit the specific application scope of the transmission structure of the present disclosure.

### Example 1

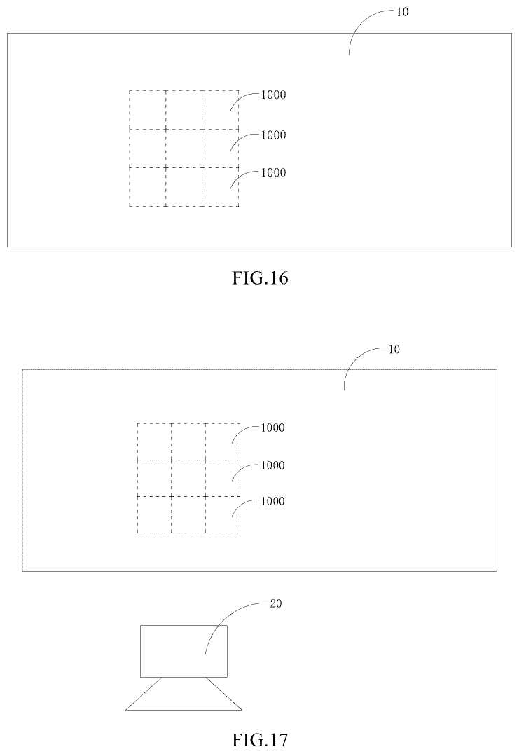

As shown in FIG. 16, the present disclosure also provides an element, that is a screen 10, including the transmission structure 1000 described above. Optionally, the transmission structure 1000 may be periodically arranged in the display area of the screen 10 to shorten the preparation time of the screen 10. In particular, when the size of the display area is large, this arrangement is preferred. Of course, the transmission structure 1000 may also be arranged non-periodically in the display area of the screen 10 to improve the overall diffuse reflection effect of the display area. In particular, when the size of the display area is small, this arrangement is preferred. Those skilled in the art may select the above arrangement according to the actual situation, so as to achieve the purpose of balancing the diffuse reflection effect of the display area and the control of the preparation complexity and preparation time of the screen 10.

By the above screen, the electromagnetic waves carrying complete image information can be projected onto the screen 10 to form an image (real image) and be diffusely reflected on the projection surface of the screen 10 within a wide frequency band range, so that the projected electromagnetic waves are reflected in all directions, and the above screen 10 may substantially eliminate the mirror reflection to the surrounding environment, so that an observer located on the reflection side of the screen 10 may observe clear images in all directions. At the same time, the electromagnetic waves reflected by the object may also be allowed to transmit through the screen 10, but the wavefront of the transmitted electromagnetic waves will not be disturbed, so that the energy of the transmitted electromagnetic waves is concentrated on the transmission side, which is conducive for the observer to capture the complete wavefront information of the transmitted electromagnetic waves of the object on the transmission side of the screen 10, and thus clearly identify the object.

### Example 2

As shown in FIG. 17, the present disclosure also provides a projection system, including: the screen 10 described above, and a projection device 20 configured to project light carrying image information onto the screen 10 to display an image. Since the operating frequency band of the transmission structure 1000 is a wide frequency band, for example, it may cover the entire visible light band, the image projected by the projection device 20 may be black and white or colored, thereby further improving the projection imaging effect of the transmission structure in the prior art.

By the above projection system, the electromagnetic waves carrying complete image information can be projected by the projection device 20 onto the screen 10 to form an image (real image) on the projection surface of the screen and occur diffuse reflection within a wide frequency band range, and the above screen 10 may substantially eliminate the mirror reflection to the surrounding environment, so that the projected electromagnetic waves are reflected in all directions, and thus an observer located on the reflection side of the screen 10 may observe clear images in all directions. At the same time, the electromagnetic waves reflected by the object may transmit through the screen 10 and retain the complete wavefront information of the transmitted electromagnetic waves of the object, thereby facilitating the observer's clear identification of the object on the transmission side of the screen 10. In particular, considering that the aforementioned screen 10 can also have a certain degree of transparency, the above projection system may be used as a head-up display device for automobiles.

### Example 3

The present disclosure provides an element, that is glass, including the transmission structure 1000 described above. Optionally, the transmission structure 1000 may be periodically arranged in part or all areas of the glass to shorten the preparation time of the glass. For example, when the size of the arrangement area is large, it may be arranged in the periodic manner. Of course, the transmission structure 1000 may also be non-periodically arranged in part or all areas of the glass to improve the overall diffuse reflection effect of the arrangement area. For example, when the size of the arrangement area is small, it may be arranged in the non-periodic manner. Those skilled in the art may select the above arrangement according to the actual situation, so as to achieve the purpose of balancing the diffuse reflection effect of the arrangement area and the control of the preparation complexity and preparation time of the glass. The schematic structural diagram of the above glass may refer to the schematic structural diagram of the screen 10 described above, and will not be described repeatedly here.

By the above glass, the electromagnetic waves carrying complete image information can be projected onto the glass to form an image (real image) and be diffusely reflected on the projection surface of the glass within a wide frequency band range, so that the projected electromagnetic waves are reflected in all directions, and the above glass may substantially eliminate the mirror reflection to the surrounding environment, so that an observer located on the reflection side of the glass may observe clear images in all directions. At the same time, the electromagnetic waves reflected by the object may also transmit through the glass, but the wavefront of the transmitted electromagnetic waves will not be disturbed, so the energy of the transmitted electromagnetic waves is concentrated on the transmission side, which is conducive for the observer to capture the complete wavefront information of the transmitted electromagnetic waves of the object on the transmission side of the glass, and thus clearly identify the object.

Optionally, the above glass can be used to prepare a glass curtain wall of a building, showcase glass. or automobile glass, etc., which is conducive to simultaneously achieving effects of reducing light pollution, not affecting the sight of people in a house or vehicle, and making the house or vehicle warm in winter and cool in summer.

In some implementations, the transmittance of the electromagnetic wave of the glass is less than or equal to a preset value. Specifically, the transmittance of the electromagnetic wave of the glass may be less than or equal to 50%, so that when the light illumination on both sides of the transmission structure 1000 does not differ greatly, the illumination in the house or vehicle can be reduced, which is conducive to making it difficult for people outside the house or vehicle to see the scene in the house or vehicle, thereby ensuring the privacy of the people in the house or vehicle to a certain extent, while not affecting the people in the house or vehicle observing the scene outside the house or vehicle. In some other implementations, the transmittance of the first transmission unit 100 and the second transmission unit 200 can be appropriately reduced, for example, the transmittance can be reduced to be less than or equal to 50%. Optionally, the electromagnetic wave incident surface and/or the electromagnetic wave exit surface of the glass may be covered with a film that reduces transmission or a film that increases reflection (not shown), but this method easily introduces additional mirror reflection and thus reduces the diffuse reflection effect of the glass.

### Example 4

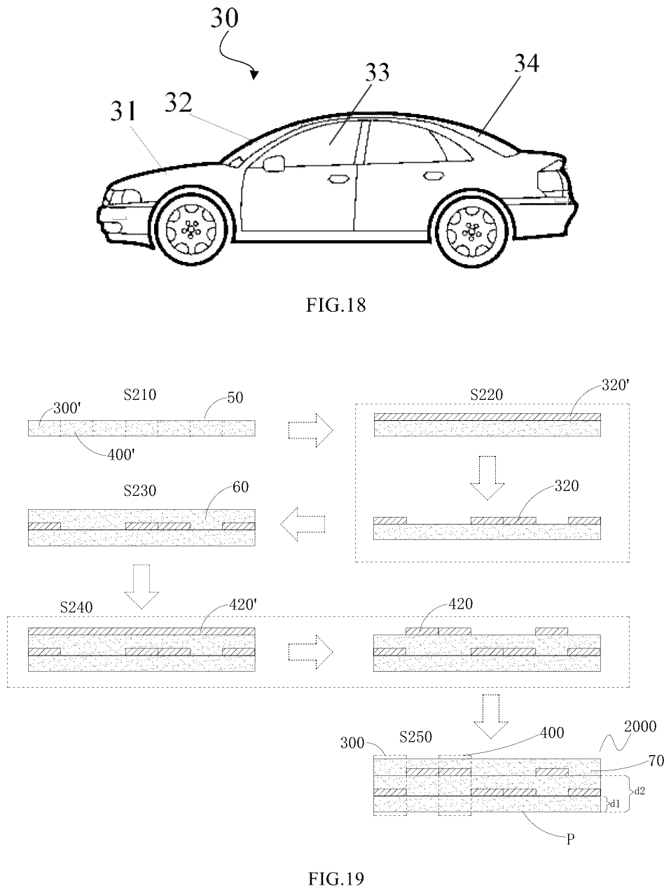

As shown in FIG. 18, the present disclosure also provides a vehicle 30, including: a vehicle body 31; and the glass described above, which is disposed on the vehicle body 31. Optionally, the above glass includes side window glass 33 and rear window glass 34 of the vehicle.

Through the above arrangement, the vehicle 30 can eliminate light pollution caused by the mirror reflection on the glass surface within the visible light frequency band range without reducing the transparency of the glass, so that people in the vehicle can still clearly see the scene outside the vehicle, and the transmittance of the glass described above is not high (usually less than 50%), which is conducive to protecting the privacy of people in the vehicle.

In some implementations, the glass further includes a windshield 32 including a projection portion; and a projection device that is disposed inside the vehicle body 31 and configured to project light carrying image information onto the projection portion to display an image. Taking FIG. 18 as an example, the projection device may be disposed on the side of the vehicle body 31 close to the bottom of the windshield 32, which is conducive to better projecting the image onto the projection portion of the windshield 32. Through the above arrangement, it is conducive to additionally installing a head-up display device, and thus the driving information about the car can be displayed to the user by projecting onto the windshield 32 without reducing the haze of the windshield 32, so that the user can still see clearly the road conditions outside, thereby ensuring driving safety. In addition, the above vehicle may also use the windshield 320 as a large screen to display projected images or video resources when not driving, so as to fully expand the use of the windshield 32 (realizing an in-vehicle theater), improving the technological sense of the vehicle and giving users a good experience.

### Example 5

The present disclosure provides an element, that is a film, including the transmission structure 1000 described above. Optionally, the film may be a flexible film, which may include: a flexible substrate; and the transmission structure 1000 described above disposed on the flexible substrate. The introduction of the flexible substrate does not introduce additional mirror reflection. Optionally, a material of the flexible substrate may be the same as the material of the aforementioned first and second matrices. Optionally, the material of the flexible substrate may be at least one of polyvinyl alcohol (PVA), polyester (PET), polyimide (PI), and polyethylene naphthalene glycol ester (PEN).

The above flexible film can realize the following effects in a wide frequency band range: the wavefront of the transmitted waves is substantially not disturbed, the reflected waves form obvious diffuse reflection, and the mirror reflection to the surrounding environment is substantially eliminated. In particular, based on the characteristics of the flexible film, the flexible film may be attached to surfaces of an object with different surface shapes (such as flat surface, curved surface, etc.), which is conducive to broadening the application scope of the transmission structure. For example, the above flexible film may be attached to a display surface of a mobile phone. A display screen of an existing mobile phone includes a curved screen, or a waterfall screen, etc., so the above flexible screen may be better fitted with the above display screen, thereby improving the mirror reflection or glare problem of the display screen of the mobile phone to an environmental object.

It should be noted that numbers expressing quantities or properties used to describe and claim certain embodiments of the present disclosure should be understood to be expressed by the terms “roughly”, “about”, “approximately” or “substantially” in some cases. For example, unless stated otherwise, “roughly”, “about”, “approximately” or “substantially” may indicate a ±20% variation of the value it describes. Accordingly, in some embodiments, the numerical parameters used in the description and claims are approximations that may vary depending on the desired characteristics of the individual embodiment. In some embodiments, numerical parameters should consider the specified significant digits and use a general digit preservation method. Although the numerical ranges and parameters used to confirm the breadth of the ranges in some embodiments of the present disclosure are approximations, such numerical values are set as accurate as possible within the feasible range in specific embodiments.

Each technical feature of the above embodiments may be combined in any way. To simplify the description, not all possible combinations of each technical feature in the above embodiments are described. However, as long as there is no contradiction in the combination of these technical features, all should be considered to be within the scope of the present description.

The above embodiments merely represent several implementations of the present disclosure, and the description thereof is more specific and detailed, but it should not be construed as limiting the scope of the present disclosure. It should be noted that, several modifications and improvements may be made for those of ordinary skill in the art without departing from the concept of the present disclosure, which are all within the protection scope of the present disclosure. Therefore, the protection scope of the present disclosure shall be subject to the appended claims.

1. A transmission structure, comprising
a matrix having an electromagnetic wave incident surface and comprising a plurality of first transmission portions and a plurality of second transmission portions randomly distributed;
wherein each of the first transmission portions is disposed with a first medium block to form a first transmission unit, and a thickness of the matrix between the first medium block and the electromagnetic wave incident surface is a non-zero first thickness;
wherein each of the second transmission portions is disposed with a second medium block to form a second transmission unit, a thickness of the matrix between the second medium block and the electromagnetic wave incident surface is a non-zero second thickness, and the second thickness is different from the first thickness; and
wherein when electromagnetic waves are incident on the first and second transmission units,
the transmitted electromagnetic wave of the first transmission unit has a first transmission phase φₜ₁, the transmitted electromagnetic wave of the second transmission unit has a second transmission phase φₜ₂, and the first transmission phase φₜ₁ and the second transmission phase φₜ₂ satisfy 0≤|φₜ₁−φₜ₂|≤0.5 π within a preset frequency band;
a reflected electromagnetic wave of the first transmission portion is a first reflected electromagnetic wave, a reflected electromagnetic wave of the first medium block is a second reflected electromagnetic wave, and the first thickness is configured to enable the reflected electromagnetic wave of the first transmission portion to have a first reflection phase φᵣ₁ at least through the interference of the first and second reflected electromagnetic waves;
a reflected electromagnetic wave of the second transmission portion is a third reflected electromagnetic wave, a reflected electromagnetic wave of the second medium block is a fourth reflected electromagnetic wave, and the second thickness is configured to enable the reflected electromagnetic wave of the second transmission unit to have a second reflection phase φᵣ₂ at least through the interference of the third and fourth reflected electromagnetic waves; and
the first reflection phase φᵣ₁ and the second reflection phase φᵣ₂ satisfy 0.6π≤|φᵣ₁−φᵣ₂|≤1.4π within the preset frequency band.

2. The transmission structure according to claim 1, wherein
the first thickness is configured to enable a reflection coefficient of the reflected electromagnetic wave of the first transmission unit at a reference frequency to be a real number, and the reference frequency is within the preset frequency band; and
the second thickness is configured to enable the first reflection phase φᵣ₁ and the second reflection phase φᵣ₂ to satisfy 0.8π≤|φᵣ₁−φᵣ₂|≤1.2π at the reference frequency.

3. The transmission structure according to claim 2, wherein
the second thickness is configured to enable an absolute value of difference between the first reflection phase φᵣ₁ and the second reflection phase φᵣ₂ to be π at the reference frequency.

4. The transmission structure according to claim 1, wherein
the preset frequency band comprises at least part of a visible light frequency band and/or at least part of an infrared light frequency band.

5. The transmission structure according to claim 4, wherein
the first thickness ranges from 30 nm to 120 nm, and the second thickness ranges from 110 nm to 290 nm.

6. The transmission structure according to claim 5, wherein
the first thickness ranges from 40 nm to 80 nm, and the second thickness ranges from 130 nm to 160 nm.

7. The transmission structure according to claim 1, wherein
the first and second medium blocks are made of a same material; and/or,
the first and second medium blocks have a same thickness.

8. The transmission structure according to claim 1, wherein
a material of the matrix comprises at least one of dielectric and semiconductor, and materials of the first and second medium blocks comprise at least one of metal, dielectric and semiconductor.

9. The transmission structure according to claim 8, wherein
the materials of the first and second medium blocks comprise at least one of copper, silver, gold, aluminum, platinum, silicon, and graphene.

10. The transmission structure according to claim 8, wherein
when the first medium block is made of metal, the first medium block has a preset thickness, and the preset thickness is less than or equal to a skin depth of the metal; and/or
when the second medium block is made of metal, the second medium block has a preset thickness, and the preset thickness is less than or equal to the skin depth of the metal.

11. The transmission structure according to claim 1, wherein when the electromagnetic waves are incident on the first and second transmission units, the transmittance of the first transmission unit and the transmittance of the second transmission unit are substantially consistent or the same within the preset frequency band.

12. The transmission structure according to claim 1, wherein a film that increases reflection is provided on an electromagnetic wave incident surface and/or an electromagnetic wave exit surface of the transmission structure.

13. The transmission structure according to claim 1, wherein a thickness of the first medium block ranges from 10 nm to 100 nm, and a thickness of the second medium block ranges from 10 nm to 100 nm.

14. The transmission structure according to claim 1, wherein at least one protective layer is provided on an electromagnetic wave incident surface and/or an electromagnetic wave exit surface of the transmission structure.

15. A preparation method of the transmission structure according to claim 1, comprising:
providing a first substrate, wherein the first substrate has an electromagnetic wave incident surface, and comprises a plurality of first transmission areas and a plurality of second transmission areas;
forming a patterned first medium layer on the first substrate, wherein the patterned first medium layer comprises a plurality of first medium blocks, and each of the first medium blocks and each of the first transmission areas are in one-to-one correspondence;
forming a second substrate on the first substrate and the patterned first medium layer;
forming a patterned second medium layer on the second substrate, wherein the patterned second medium layer comprises a plurality of second medium blocks, each of the second medium blocks and each of the second transmission areas are in one-to-one correspondence, the first and second medium blocks have first and second projections on the electromagnetic wave incident surface in a normal direction of the electromagnetic wave incident surface, respectively, the first and second projections are randomly distributed, and the first projection does not overlap the second projection; and
forming a third substrate on the second substrate and the patterned second medium layer,
wherein the first, second and third substrates are made of a same material, the first transmission area and at least the first medium block, a portion of the second substrate, and a portion of the third substrate corresponding to the first transmission area form first transmission unit, and the second transmission area and at least a portion of the second substrate, the second medium block, and a portion of the third substrate corresponding to the second transmission area form second transmission unit.

16. The preparation method according to claim 15, wherein
a thickness of the first substrate ranges from 30 nm to 120 nm in the first transmission unit; and
a total thickness of the first and second substrates ranges from 110 nm to 290 nm in the second transmission unit.

17. The preparation method according to claim 16, wherein
the thickness of the first substrate ranges from 40 nm to 80 nm in the first transmission unit; and
the total thickness of the first and second substrates ranges from 130 nm to 160 nm in the second transmission unit.

18. The preparation method according to claim 15, wherein
the forming a patterned first medium layer on the first substrate comprises:
forming a photoresist layer with a first pattern on the first substrate, wherein the photoresist layer with the first pattern comprises a plurality of first medium holes, and a portion of the first substrate corresponding to the first medium holes is the first transmission area;
forming first medium blocks in the first medium holes;
removing at least the photoresist layer with the first pattern; and
forming the patterned first medium layer by the plurality of the first medium blocks on the first substrate, and
the forming a patterned second medium layer on the second substrate comprises:
forming a photoresist layer with a second pattern on the second substrate, wherein the photoresist layer with the second pattern comprises a plurality of second medium holes, and a portion of the first substrate corresponding to the second medium holes is the second transmission area;
forming the second medium blocks in the second medium holes;
removing at least the photoresist layer with the second pattern; and
forming the patterned second medium layer by a plurality of the second medium blocks on the second substrate.

19. An element, comprising a transmission structure according to claim 1.

20. The element according to claim 19, wherein the element comprises at least one of a film, a screen, and glass.
